(19) United States
(12) Patent Application Publication
(10) Pub. No.: US 2026/0264255 A1
(43) Pub. Date: Sep. 10, 2026

(54) DUAL-ARM HARVESTING ROBOT SYSTEM AND CONTROL METHOD THEREOF

(71) Applicants: Suzhou Botian Automation Technology Co., Ltd., Suzhou (CN); AUBO (BEIJING) ROBOTICS TECHNOLOGY CO., LTD, Beijing (CN)

(72) Inventors: Wei LI, Suzhou (CN); Hongxing WEI, Suzhou (CN); Tianxue ZHANG, Suzhou (CN); Hongtao YANG, Suzhou (CN)

(73) Assignees: Suzhou Botian Automation Technology Co., Ltd., Suzhou (CN); AUBO (BEIJING) ROBOTICS TECHNOLOGY CO., LTD, Beijing (CN)

(21) Appl. No.: 19/430,098

(22) Filed: Dec. 22, 2025

(30) Foreign Application Priority Data
Mar. 10, 2025 (CN) 202510277065.9

(51) Int. Cl. B25J 9/16; B25J 5/00; B25J 9/00

(52) U.S. Cl. CPC B25J 9/1697; B25J 5/007; B25J 9/0087

(57) ABSTRACT

A dual-arm harvesting robot includes a robot body, a collection device, a mobile device and a robot control device. The robot body is mounted on the mobile device via a rotating and lifting waist-hip joint, the collection device is provided on the mobile device configured to carry the robot body and the collection device to move; a multi-degree-of-freedom mechanical right arm and a multi-degree-of-freedom mechanical left arm are provided on two sides of the robot body, a right-arm-end harvesting gripper is provided at a distal end of the multi-degree-of-freedom mechanical right arm, and a left-arm-end harvesting gripper is provided at a distal end of the multi-degree-of-freedom mechanical left arm; and an image acquisition device is provided on a top of the robot body, a LiDAR device is provided on the mobile device, both the image acquisition device and the LiDAR device are in data communication with the robot control device.

### CROSS-REFERENCE TO RELATED APPLICATIONS

This application claims priority to Chinese Patent Application No. 202510277065.9, filed on Mar. 10, 2025, which is incorporated herein by reference in its entirety.

### TECHNICAL FIELD

The present disclosure relates to the technical field of robotics, specifically to a dual-arm harvesting robot system and a control method thereof.

### BACKGROUND

Existing single-arm collaborative robotic arms are mounted on autonomous guided vehicle (AGV) mobile chassis and primarily patrol and inspect targets along tracks during harvesting. However, practical limitations have been identified in hardware platforms: a) a single arm cannot achieve optimal harvesting efficiency due to limited workspace; b) in practical engineering applications, operations occur not only in on-track working conditions but also in numerous non-track environments, yet existing systems lack complete autonomous navigation capabilities.

Chinese Application Publication CN111034465A discloses an efficient apple harvesting robot comprising a robot housing, a rotating assembly, a lifting assembly, a movable assembly, a grasping assembly and a cutting assembly. The robot housing includes a base and a top cover, and a periphery between the base and the top cover is fixed by a bolt. The rotating assembly is arranged on one side of a top of the top cover, the lifting assembly is arranged at a top of the rotating assembly, the movable assembly is arranged on the lifting assembly, the grasping assembly is arranged at a distal end of the movable assembly, the cutting assembly is arranged above the grasping assembly, a material collection box is arranged at the top of the top cover and beside the rotating assembly, a buffer chute is arranged on the material collection box to prevent apple damage, and the rotating assembly comprises a turntable and a gear driving mechanism. However, this patent still employs a single-arm design with limited workspace.

The present disclosure provides a dual-arm harvesting robot, adopting a humanoid upper body structure primarily comprising a waist-above architecture mounted on a mobile chassis. The dual arms of this humanoid robot differ from traditional collaborative robots in the following aspects: binocular depth cameras are added to the head and eyes for environmental intelligence cognition; forward obstacle-avoidance binocular depth cameras are installed at waist height on the chassis for close-range obstacle avoidance and dynamic path planning during movement; and target-detection depth cameras are mounted on the left-arm-end effector.

By employing dual arms, the present disclosure effectively expands the working area and substantially increases the quantity of targets collected per stop. Reduced parking frequency further enhances overall efficiency. The present disclosure adopts dual-arm collaborative operation. The humanoid robotic arm configuration is more suitable for harvesting scenarios and enables more effective cooperation. The present disclosure features complete autonomous navigation capabilities, which in the field of humanoid robotics correspond to environmental intelligence. This represents a fundamental distinction from traditional composite robots. With environmental intelligence recognition capabilities, the robot gains the foundation to autonomously accept and execute tasks, including more intelligent real-time obstacle avoidance and dynamic local path planning.

### SUMMARY

To address deficiencies in prior art, the present disclosure provides a dual-arm harvesting robot system and a control method thereof.

According to the present disclosure, the dual-arm harvesting robot system comprises: a robot body, a collection device, a mobile device and a robot control device;
wherein the robot body is mounted on the mobile device via a rotating and lifting waist-hip joint, and the collection device is provided on the mobile device; the mobile device is configured to carry the robot body and the collection device to move;
a multi-degree-of-freedom mechanical right arm and a multi-degree-of-freedom mechanical left arm are provided on two sides of the robot body, a right-arm-end harvesting gripper is provided at a distal end of the multi-degree-of-freedom mechanical right arm, and a left-arm-end harvesting gripper is provided at a distal end of the multi-degree-of-freedom mechanical left arm;
an image acquisition device is provided on a top of the robot body, a LiDAR device is provided on the mobile device, and both the image acquisition device and the LiDAR device are in data communication with the robot control device; and
the robot control device is configured to control operations of the rotating and lifting waist-hip joint, the multi-degree-of-freedom mechanical right arm, the multi-degree-of-freedom mechanical left arm, the right-arm-end harvesting gripper, the left-arm-end harvesting gripper and the mobile device.

Preferably, the image acquisition device is a first depth camera;
the first depth camera is connected to the robot body via a neck rotating joint, and the first depth camera is configured to perceive environment;
a second depth camera is provided on the robot body, and the second depth camera is configured to perform close-range obstacle avoidance and dynamic path planning; and
a third depth camera is provided on the left-arm-end harvesting gripper, and the third depth camera is configured to detect target objects for harvesting.

Preferably, the mobile device comprises: a mobile chassis; the mobile chassis is provided with a rear chassis track wheel, a rear chassis caster wheel, a chassis drive wheel, a front chassis track wheel and a front chassis caster wheel;
the front chassis track wheel and the front chassis caster wheel are located at a front end of the mobile chassis, and the rear chassis track wheel and the rear chassis caster wheel are located at a rear end of the mobile chassis; and
the chassis drive wheel is located between the front chassis track wheel and the rear chassis track wheel.

Preferably, the LiDAR device comprises: a rear LiDAR and a front LiDAR;
wherein the rear LiDAR and the front LiDAR are provided on the mobile chassis, the rear LiDAR is located at the front end of the mobile chassis, and the front LiDAR is located at the rear end of the mobile chassis; and
a rear anti-collision strip is provided at the rear end of the mobile chassis, and a front anti-collision strip is provided at the front end of the mobile chassis.

Preferably, the multi-degree-of-freedom mechanical right arm is a six-degree-of-freedom mechanical right arm;
the six-degree-of-freedom mechanical right arm comprises: a first right arm joint, a second right arm joint, a third right arm joint, a fourth right arm joint, a fifth right arm joint and a sixth right arm joint connected sequentially;
wherein the first right arm joint is connected to the robot body, and the sixth right arm joint is connected to the right-arm-end harvesting gripper;
the multi-degree-of-freedom mechanical left arm is a six-degree-of-freedom mechanical left arm;
the six-degree-of-freedom mechanical left arm comprises: a first left arm joint, a second left arm joint, a third left arm joint, a fourth left arm joint, a fifth left arm joint and a sixth left arm joint connected sequentially;
the first left arm joint is connected to the robot body, and the sixth left arm joint is connected to the left-arm-end harvesting gripper;
the rotating and lifting waist-hip joint comprises: a waist rotating joint, a first waist lifting joint and a second waist lifting joint connected sequentially; and
the waist rotating joint is connected to the robot body, and the second waist lifting joint is connected to the mobile device.

Preferably, the robot control device comprises: a visual service device, a motion planning device, a robotic arm control device, a vehicle control device, a software communication device, a Python-AB-API device and a natural language interaction device;
wherein the visual service device is configured to capture scene image data via the image acquisition device, segment harvesting targets from the scene image data using a visual weighting model file, and calculate positional information of the harvesting targets;
the motion planning device is configured to plan motion paths for the multi-degree-of-freedom mechanical right arm and the multi-degree-of-freedom mechanical left arm based on the positional information of the harvesting targets and workspace configurations;
the robotic arm control device is configured to receive the motion paths from the motion planning device and control the multi-degree-of-freedom mechanical right arm and the multi-degree-of-freedom mechanical left arm to execute harvesting along the motion paths;
the vehicle control device is configured to interact with the LiDAR device, the LiDAR device performs simultaneous localization and mapping (SLAM) mapping and navigation, and the vehicle control device is configured to control operation of the mobile device;
the software communication device is configured to perform inter-device communication;
the Python-AB-API device is configured to invoke devices and/or receive information from the devices; and
the natural language interaction device is configured to implement human-machine interaction.

The present disclosure further provides a dual-arm harvesting robot control method, wherein the dual-arm harvesting robot control method is configured to control the dual-arm harvesting robot system, the method comprises following steps:
vehicle chassis motion control step: performing SLAM mapping via the LiDAR device; planning a motion trajectory of the mobile device to enable the mobile device to navigate and patrol according to the motion trajectory; capturing real-time images of harvesting targets via the image acquisition device; tracking and detecting the harvesting targets based on the captured image data to obtain positional information of the harvesting targets; and adjusting a speed of the mobile device in real time based on the positional information of the harvesting targets;
robotic arm motion control step: defining motion spaces of the multi-degree-of-freedom mechanical right arm and the multi-degree-of-freedom mechanical left arm to position the harvesting targets within the motion spaces; determining joint angles of the multi-degree-of-freedom mechanical right arm and the multi-degree-of-freedom mechanical left arm via inverse kinematics based on the positional information of the harvesting targets; and obtaining collision-free motion paths for the multi-degree-of-freedom mechanical right arm and the multi-degree-of-freedom mechanical left arm based on the joint angles and collision-avoidance configuration parameters, enabling the right-arm-end harvesting gripper and the left-arm-end harvesting gripper to approach the harvesting targets without collision;
dual-arm collaborative motion control step: optimizing and adjusting the motion paths of the multi-degree-of-freedom mechanical right arm and the multi-degree-of-freedom mechanical left arm to prevent overlap of the motion spaces of the multi-degree-of-freedom mechanical right arm and the multi-degree-of-freedom mechanical left arm;
target tracking and feedback step: performing real-time tracking of the harvesting targets and feeding back poses of the harvesting targets; and dynamically adjusting the motion paths of the multi-degree-of-freedom mechanical right arm and the multi-degree-of-freedom mechanical left arm based on the poses of the harvesting targets; and
cutting and grasping step: completing cutting and grasping operations after the right-arm-end harvesting gripper and the left-arm-end harvesting gripper reach positions of the harvesting targets; and placing the harvested targets into the collection device.

Preferably, the step of determining the joint angles of the multi-degree-of-freedom mechanical right arm and the multi-degree-of-freedom mechanical left arm via inverse kinematics specifically comprises following steps:
robot model and coordinate system establishment step:
establishing coordinate systems for each joint of the multi-degree-of-freedom mechanical right arm and the multi-degree-of-freedom mechanical left arm using the Denavit-Hartenberg (D-H) parameter method; and assigning a number i (i=1, 2, . . . , 6) to each joint and defining D-H parameters for each joint:
a_{i−1}: link length, the distance from the z_{i−1}-axis to the z_i-axis along the x_{i−1}-axis;
α_{i−1}: link twist angle, the angle between the z_{i−1}-axis and the z_i-axis about the x_{i−1}-axis;
d_i: joint offset, the distance from the x_{i−1}-axis to the x_i-axis along the z_{i−1}-axis; and
θ_i: joint angle, the angle between the x_{i−1}-axis and the x_i-axis about the z_{i−1}-axis;
inverse kinematics solving steps:
defining the pose transformation matrix from the base coordinate frame to the end-effector as T:

$$T = [ [ n\_x , o\_x , a\_x , p\_x ] , [ n\_y , o\_y , a\_y , p\_y ] , [ n\_z , o\_z , a\_z , p\_z ] , [ 0 , 0 , 0 , 1 ] ]$$

using the set values in the aforementioned matrix T as known values for inverse solution calculation in the following formulas:
adopting a human-robot collaborative robotic arm in the present disclosure, where adjacent joints 2, 3, and 4 at the shoulder, elbow, and wrist are parallel to each other, and noting that its inverse kinematics has a closed-form solution; based on the forward kinematics process, deriving the transformation matrix of joint 4 coordinate frame relative to joint 1 coordinate frame as follows:

$${T}_{14} = {T}_{12} {T}_{23} {T}_{34} = [ [ C 234 , - S 234 , 0 , C 2 + a\_ 3 C 23 ] , [ 0 , 0 , 1 , d\_ 4 ] , [ - S 234 , - C 234 , 0 , - a\_ 2 S 2 - a\_ 3 S 23 ] , [ 0 , 0 , 0 , 1 ] ]$$

$$C 234 = cos ( θ\_ 2 + θ\_ 3 + θ\_ 4 )$$

$$S 23 = sin ( θ\_ 2 + θ\_ 3 )$$

addressing the robotic arm with parallel joints 2, 3, and 4, and utiliz_i-ng the second row of T₁₄ being [0, 0, 1, d_4], the inverse kinematics process involves first obtaining the angles for joints 1, 5, and 6, and then solving for the angles of joints 2, 3, and 4;
solving for the angles of joints 1, 5, and 6:
based on T₁₄ and kinematic equation:

$${T}_{14} {T}_{45} = {T}_{12} {T}_{23} {T}_{34} {T}_{45} = {T}_{01}^{- 1} {T}_{06} {T}_{56}^{- 1}$$

$$wherein ,$$

$${T}_{01}^{- 1} = [ [ C 1 , S 1 , 0 , 0 ] , [ - S 1 , C 1 , 0 , 0 ] , [ 0 , 0 , 1 , - d\_ 1 ] , [ 0 , 0 , 0 , 1 ] ]$$

$${T}_{06} = [ [ n\_x , o\_x , a\_x , p\_x ] , [ n\_y , o\_y , a\_y , p\_y ] , [ n\_z , o\_z , a\_z , p\_z ] , [ 0 , 0 , 0 , 1 ] ]$$

$${T}_{56}^{- 1} = [ [ C 6 , 0 , - S 6 , 0 ] , [ - S 6 , 0 , - C 6 , 0 ] , [ 0 , 1 , 0 , - d\_ 6 ] , [ 0 , 0 , 0 , 1 ] ]$$

$${T}_{45} = [ [ C 5 , - S 5 , 0 , 0 ] , [ 0 , 0 , - 1 , - d\_ 5 ] , [ S 5 , C 5 , 0 , 0 ] , [ 0 , 0 , 0 , 1 ] ]$$

expanding the matrix operations on both sides of the equation, and using the second row [0, 0, 1, d_4] of T₁₄, deriving the following equations from the elements of the second row of the expanded matrix:

$$[ S 5 , C 5 , 0 , d\_ 4 ] = [ - S 1 n\_x + C 1 n\_y , - S1o\_x + C1o\_y , - S1a\_x + C1a\_y , - S1p\_x + C1p\_y ]$$

$$[ [ C 6 , 0 , - S 6 , 0 ] , [ - S 6 , 0 , - C 6 , 0 ] , [ 0 , 1 , 0 , - d\_ 6 ] , [ 0 , 0 , 0 , 1 ] ]$$

establishing four equations based on the above formula as follows:

$$d\_ 4 = - d\_ 6 ( - S1a\_x + C1a\_y ) - S 1 p\_x + C1p\_y ;$$

$$C 5 = - S1a\_x + C1a\_y ;$$

$$S 5 = ( - S1n\_x + C1n\_y ) C 6 - ( - S1o\_x + C1o\_y ) S 6 ;$$

$$0 = - ( - S1n\_x + C1n\_y ) S 6 - ( - S1o\_x + C1o\_y ) C 6$$

$$solving for joint 1 angle from the first equation :$$

$$C 1 ( a\_y d\_ 6 - p\_y ) - S 1 ( a\_x d\_ 6 - p\_x ) = - d\_ 4 ;$$

$$letting : m = a\_y d\_ 6 - p\_y , n = a\_x d\_ 6 - p\_x , then :$$

$$θ\_ 1 = arctan 2 ( m , n ) - arctan 2 ( - d\_ 4 , \sqrt{{m}^{2} + {n}^{2} - d\_ {4}^{2}} )$$

$$or , θ\_ 1 = arctan 2 ( m , n ) - arctan 2 ( - d\_ 4 , - \sqrt{{m}^{2} + {n}^{2} - d\_ {4}^{2}} )$$

$$solving for joint 5 angle from the second equation :$$

$$θ\_ 5 = arccos ( - S1a\_x + C1a\_y )$$

$$or , θ\_ 5 = - arccos ( - S1a\_x + C1a\_y )$$

solving for joint 6 angle from the third and fourth equations: letting: —S1n_x+C1n_y=m1, —S1o_x+C1o_y=n1, then:

$$S 5 = m 1 C 6 - n 1 S 6$$

$$0 = m 1 S 6 + n 1 C 6$$

$$solving gives : S 6 = - n 1 / S 5 , C 6 = m 1 / S 5$$

$$θ\_ 6 = arctan 2 ( - n 1 / S 5 , m 1 / S 5 ) or θ\_ 6 = arctan ( - n 1 / m 1 )$$

$$solving for the angles of joints 2 , 3 , and 4 :$$

$$using the equation : {T}_{14} {T}_{45} = {T}_{12} {T}_{23} {T}_{34} {T}_{45} = {T}_{01}^{- 1} {T}_{06} {T}_{56}^{- 1}$$

$${T}_{14} = {T}_{01}^{- 1} {T}_{06} {{T}_{56}^{- 1} ( {T}_{45} )}^{- 1} = [ [ C 234 , - S 234 , 0 , C 2 a\_ 2 + a\_ 3 C 23 ] , [ \text{} 0 , 0 , 1 , d\_ 4 ] , [ - S 234 , - C 234 , 0 , - a\_ 2 S 2 - a\_ 3 S 23 ] , [ 0 , 0 , 0 , 1 ] ]$$

given that 0_1, 0_5, and 0_6 are known, then:
all elements in T₀₁⁻¹ T₀₆T₅₆⁻¹T₄₅⁻¹=T₁₄ are known quantities; letting x=T₁₄ (1,4), denoting the element in the first row and fourth column of the matrix; letting y=T₁₄ (3,4), denoting the element in the third row and fourth column, therefore:

$$C 2 a\_ 2 + a\_ 3 C 23 = x ;$$

$$a\_ 2 S 2 + a\_ 3 S 23 = - y ;$$

$$deriving : a\_ {2}^{2} + a\_ {3}^{2} + 2 a\_ 2 a\_ 3 ( C 23 C 2 + S 23 S 2 ) = {x}^{2} + {y}^{2} = a\_ {2}^{2} + a\_ {3}^{2} + 2 a\_ 2 a\_ 3 C 3 ;$$

$$θ\_ 3 = arccos ( \frac{x \hat{} 2 + y \hat{} 2 - a\_ 2 \hat{} 2 - a\_ 3 \hat{} 2}{2 a\_ 2 a\_ 3} )$$

transforming the compound angle formulas into single angles from the equations for x and y:

$$x = ( a\_ 3 C 3 + a\_ 2 ) C 2 - a\_ 3 S 3 S 2$$

$$- y = a\_ 3 S 3 C 2 + ( a\_ 3 C 3 + a\_ 2 ) S 2$$

solving the system of equations for C2 and S2:

$$[ C 2 S 2 ] = [ [ a\_ 3 C 3 + a\_ 2 - a\_ 3 S 3 ] , [ a\_ 3 S 3 a\_ 3 C 3 + a 2 ] ] [ x - y ]$$

$$therefore : θ\_ 2 = arctan 2 ( S 2 , C 2 )$$

using the expansion of the T₁₄ matrix:

$$C 234 = {T}_{14} ( 1 , 1 )$$

$$- S 234 = {T}_{14} ( 1 , 2 )$$

solving for joint 4:

$$θ\_ 4 = arctan 2 ( - {T}_{14} ( 1 , 2 ) , {T}_{14} ( 1 , 1 ) ) - θ\_ 2 - θ\_ 3$$

completing the solution for all six angles θ_1, θ_2, θ_3, θ_4, θ_5, and θ_6.

Preferably, the step of obtaining collision-free motion paths for the multi-degree-of-freedom mechanical right arm and the multi-degree-of-freedom mechanical left arm specifically comprises following steps:
modeling the robot's workspace in three-dimensional space, describing obstacles as polygons, and recording position and dimension parameters of the obstacles;
wherein collision-avoidance configuration parameters comprise: robot shape and dimensions, including the robot's radius, length and width; robot motion constraints, including maximum velocity, acceleration and turning radius; and a safety distance, wherein the safety distance is a minimum distance between the robot and obstacles;
generating a collision-free path by applying a randomized tree search algorithm, iteratively creating random new points in three-dimensional space, expanding the search tree from a start point toward these points, and terminating the process when the tree reaches a harvesting target point;
fitting path points of the collision-free path into a smooth curve using spline interpolation method;
assigning appropriate velocities to each path point on the collision-free path according to the robot's motion constraints and task requirements;
monitoring the distance between the robot and surrounding obstacles in real-time during collision-free path generation process, to ensure compliance with the safety distance requirement at all operational moments; and
performing global collision detection on the entire collision-free path after completing generation of the collision-free path, to validate obstacle-free motion throughout the robot's complete trajectory, and replanning the collision-free path if collisions are detected.

Preferably, the dual-arm collaborative motion control step comprises:
assigning harvesting targets within different spatial ranges to the multi-degree-of-freedom mechanical right arm and the multi-degree-of-freedom mechanical left arm based on positional information of harvesting targets extracted from the image data; and
determining entry of harvesting targets into the workspace through the multi-degree-of-freedom mechanical left arm, controlling movement speed and halting operations of the mobile device according to configured optimal harvesting position parameters after determining entry of harvesting targets into the workspace, and activating harvesting tasks in respective workspaces for the multi-degree-of-freedom mechanical right arm and the multi-degree-of-freedom mechanical left arm; scheduling and applying motion path planning from the robotic arm motion control step for harvesting operations, and continuing the process until no harvestable targets remain in the workspaces of the multi-degree-of-freedom mechanical right arm and the multi-degree-of-freedom mechanical left arm; and switching to an inspection state for navigation after completing harvesting operations.

Compared with the prior art, the beneficial effects of the present disclosure are as follows.

The present disclosure improves harvesting efficiency. The dual-arm harvesting robot can simultaneously execute multiple harvesting tasks, significantly enhancing harvesting efficiency.

The present disclosure achieves higher flexibility and adaptability. The dual-arm design enables collaborative operation, allowing the robot to harvest tomatoes obscured by foliage and adapt to complex tomato cultivation environments.

The present disclosure demonstrates superior intelligence and autonomy. Equipped with more advanced visual recognition systems and intelligent control systems, the dual-arm harvesting robot achieves finer and more accurate real-time environmental perception, enabling autonomous decision-making and harvesting task execution.

### BRIEF DESCRIPTION OF THE DRAWINGS

By reading the following detailed descriptions of non-limiting embodiments with reference to the accompanying drawings, other features, objectives, and advantages of the present disclosure will become more apparent. In the drawings:

FIG. 1 shows the three-dimensional structural schematic diagram (Version 1) of the dual-arm harvesting robot system;

FIG. 2 shows the structural schematic diagram of the depth camera mounted on the robot head (with highlighting);

FIG. 3 shows the structural schematic diagram (Version 1) of the mobile device;

FIG. 4 shows the structural schematic diagram (Version 2) of the mobile device;

FIG. 5 shows the structural schematic diagram of the waist rotating joint (with highlighting);

FIG. 6 shows the structural schematic diagram of the waist lifting joint (with highlighting);

FIG. 7 shows the structural schematic diagram of the multi-degree-of-freedom mechanical right arm and the multi-degree-of-freedom mechanical left arm (with highlighting);

FIG. 8 shows the architectural schematic diagram of the robot control device;

FIG. 9 shows the schematic diagram highlighting that the tomato cultivation scenario is an unstructured environment;

FIG. 10 shows the principle schematic diagram of the safety collaborative motion rules for the multi-degree-of-freedom mechanical right arm and the multi-degree-of-freedom mechanical left arm;

FIG. 11 shows the harvesting schematic diagram (Case 1) of the robot;

FIG. 12 shows the harvesting schematic diagram (Case 2) of the robot;

FIG. 13 shows the structural schematic diagram (Version 1) of the left-arm-end harvesting gripper;

FIG. 14 shows the structural schematic diagram (Version 2) of the left-arm-end harvesting gripper;

FIG. 15 shows the top-view schematic diagram of the dual-arm harvesting robot system;

FIG. 16 shows the rear-view schematic diagram of the dual-arm harvesting robot system;

FIG. 17 shows the bottom-view schematic diagram of the dual-arm harvesting robot system;

FIG. 18 shows the three-dimensional structural schematic diagram (Version 2) of the dual-arm harvesting robot system;

FIG. 19 shows the three-dimensional structural schematic diagram (Version 3) of the dual-arm harvesting robot system;

FIG. 20 shows the harvesting schematic diagram (Case 3) of the robot;

FIG. 21 shows the system connection schematic diagram of the robot;

FIG. 22 shows the step schematic diagram of the robot control method;

FIG. 23 shows the step schematic diagram of determining joint angles of the multi-degree-of-freedom mechanical right arm and the multi-degree-of-freedom mechanical left arm via inverse kinematics;

FIG. 24 shows the step schematic diagram of obtaining collision-free motion paths for the multi-degree-of-freedom mechanical right arm and the multi-degree-of-freedom mechanical left arm;

FIG. 25 shows the step schematic diagram of the dual-arm collaborative motion control steps; and

FIG. 26 shows the schematic diagram of the dual-arm safety collaborative motion rules for the multi-degree-of-freedom mechanical right arm and the multi-degree-of-freedom mechanical left arm.

### DETAILED DESCRIPTION OF THE EMBODIMENTS

The present disclosure will now be described in detail through specific embodiments. The following embodiments will assist those skilled in the art to further understand the present disclosure but shall not limit the present disclosure in any form. It should be noted that those skilled in the art may make several variations and improvements without departing from the inventive concept of the present disclosure. All such modifications fall within the protection scope of the present disclosure.

### Embodiment 1

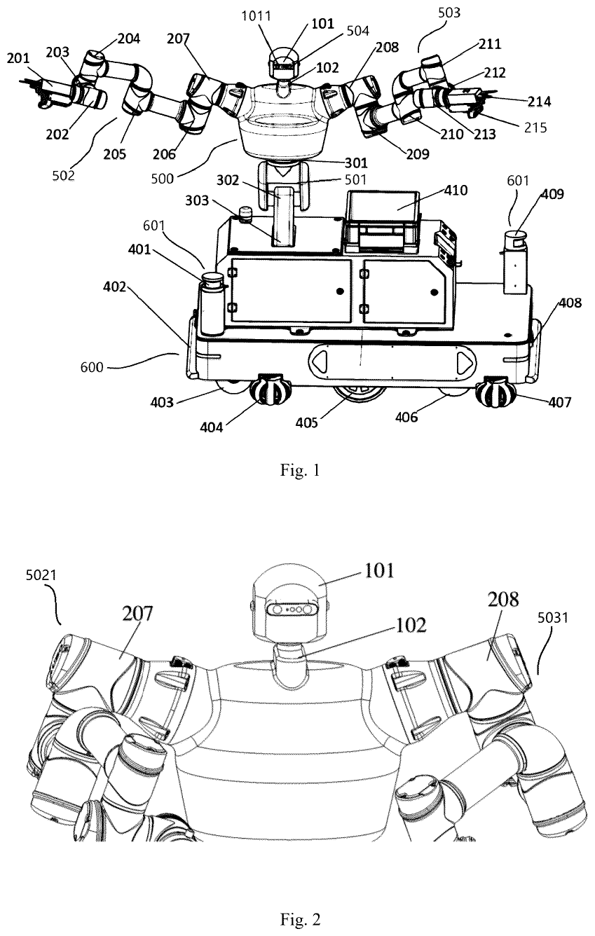

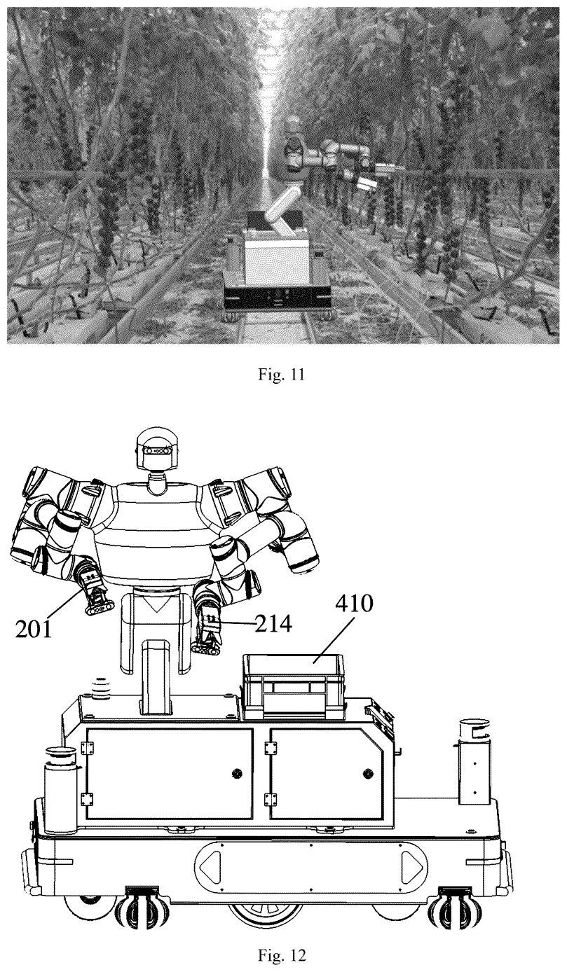

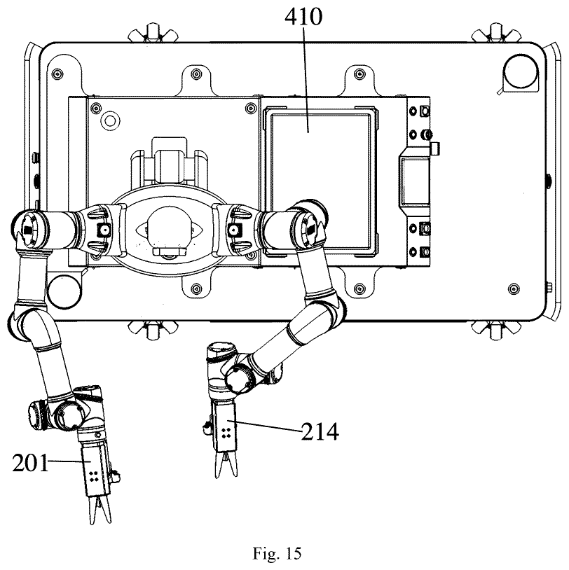

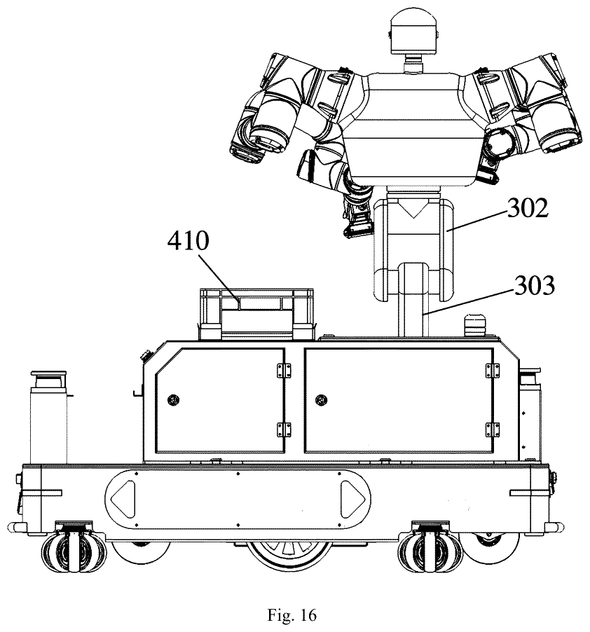

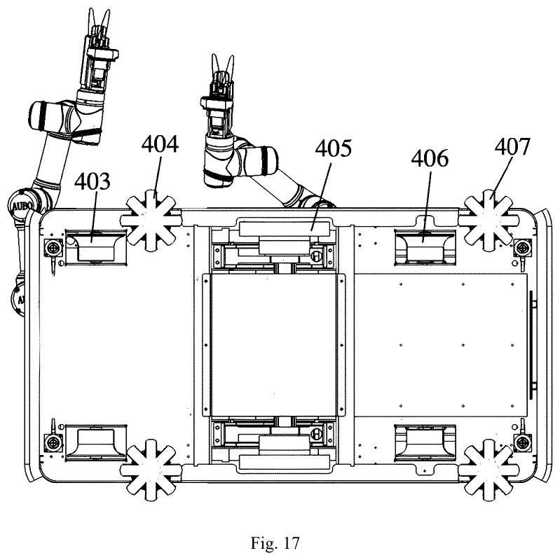

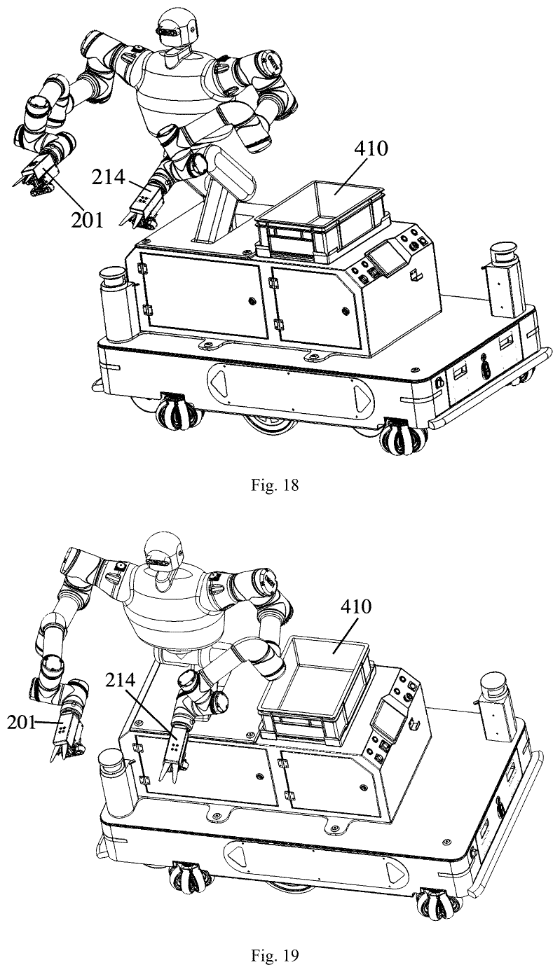

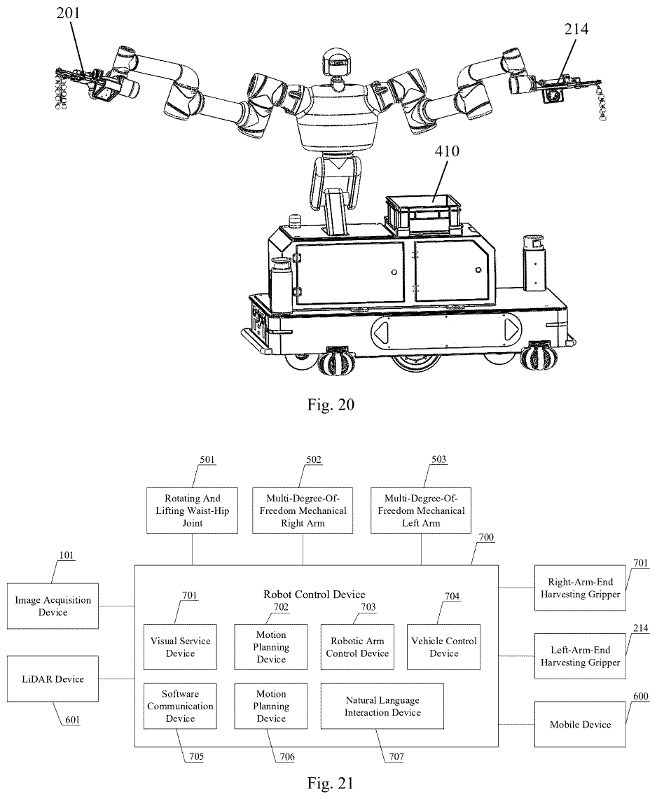

As shown in FIGS. 1-20, this embodiment provides a dual-arm harvesting robot system, comprising: a robot body 500, a collection device 410, a mobile device 600 and a robot control device 700; the robot body 500 is mounted on the mobile device 600 via a rotating and lifting waist-hip joint 501, and the collection device 410 is provided on the mobile device 600; the mobile device 600 is configured to carry the robot body 500 and the collection device 410 to move; a multi-degree-of-freedom mechanical right arm 502 and a multi-degree-of-freedom mechanical left arm 503 are provided on two sides of the robot body 500, a right-arm-end harvesting gripper 201 is provided at a distal end of the multi-degree-of-freedom mechanical right arm 502, and a left-arm-end harvesting gripper 214 is provided at a distal end of the multi-degree-of-freedom mechanical left arm 503; an image acquisition device 101 is provided on a top of the robot body 500, a LiDAR device 601 is provided on the mobile device 600, and both the image acquisition device 101 and the LiDAR device 601 are in data communication with the robot control device 700; and the robot control device 700 is configured to control operations of the rotating and lifting waist-hip joint 501, the multi-degree-of-freedom mechanical right arm 502, the multi-degree-of-freedom mechanical left arm 503, the right-arm-end harvesting gripper 201, the left-arm-end harvesting gripper 214 and the mobile device 600. The collection device 410 serves as a fruit basket.

The mobile device 600 comprises: a mobile chassis 411; the mobile chassis 411 is provided with a rear chassis track wheel 403, a rear chassis caster wheel 404, a chassis drive wheel 405, a front chassis track wheel 406 and a front chassis caster wheel 407; the front chassis track wheel 406 and the front chassis caster wheel 407 are located at a front end of the mobile chassis 411, and the rear chassis track wheel 403 and the rear chassis caster wheel 404 are located at a rear end of the mobile chassis 411; and the chassis drive wheel 405 is located between the front chassis track wheel 406 and the rear chassis track wheel 403.

The LiDAR device 601 comprises: a rear LiDAR 401 and a front LiDAR 409; the rear LiDAR 401 and the front LiDAR 409 are provided on the mobile chassis 411, the rear LiDAR 401 is located at the front end of the mobile chassis 411, and the front LiDAR 409 is located at the rear end of the mobile chassis 411; and a rear anti-collision strip 402 is provided at the rear end of the mobile chassis 411, and a front anti-collision strip 408 is provided at the front end of the mobile chassis 411.

The image acquisition device 101 is a first depth camera 1011; the first depth camera 1011 is connected to the robot body 500 via a neck rotating joint 102, and the first depth camera 1011 is configured to perceive environment; a second depth camera 504 is provided on the robot body 500, and the second depth camera 504 is configured to perform close-range obstacle avoidance and dynamic path planning; and a third depth camera 215 is provided on the left-arm-end harvesting gripper 214, and the third depth camera 215 is configured to detect target objects for harvesting. The first depth camera 1011 is a D435 RGB-D depth camera.

The underlying API of the first depth camera 1011 collects image data streams, extracts image frames from the image data streams, aligns two-dimensional (2D) images with depth information-containing image frames, performs inference via a you only look once (YOLO) detection device to obtain result data, and exchanges result data through message queuing telemetry transport (MQTT).

The multi-degree-of-freedom mechanical right arm 502 is a six-degree-of-freedom mechanical right arm 5021; the six-degree-of-freedom mechanical right arm 5021 comprises: a first right arm joint 207, a second right arm joint 206, a third right arm joint 205, a fourth right arm joint 204, a fifth right arm joint 203 and a sixth right arm joint 202 connected sequentially; the first right arm joint 207 is connected to the robot body 500, and the sixth right arm joint 202 is connected to the right-arm-end harvesting gripper 201; the multi-degree-of-freedom mechanical left arm 503 is a six-degree-of-freedom mechanical left arm 5031; the six-degree-of-freedom mechanical left arm 5031 comprises: a first left arm joint 208, a second left arm joint 209, a third left arm joint 210, a fourth left arm joint 211, a fifth left arm joint 212 and a sixth left arm joint 213 connected sequentially; the first left arm joint 208 is connected to the robot body 500, and the sixth left arm joint 213 is connected to the left-arm-end harvesting gripper 214; the rotating and lifting waist-hip joint 501 comprises: a waist rotating joint 301, a first waist lifting joint 302 and a second waist lifting joint 303 connected sequentially; and the waist rotating joint 301 is connected to the robot body 500, and the second waist lifting joint 303 is connected to the mobile device 600.

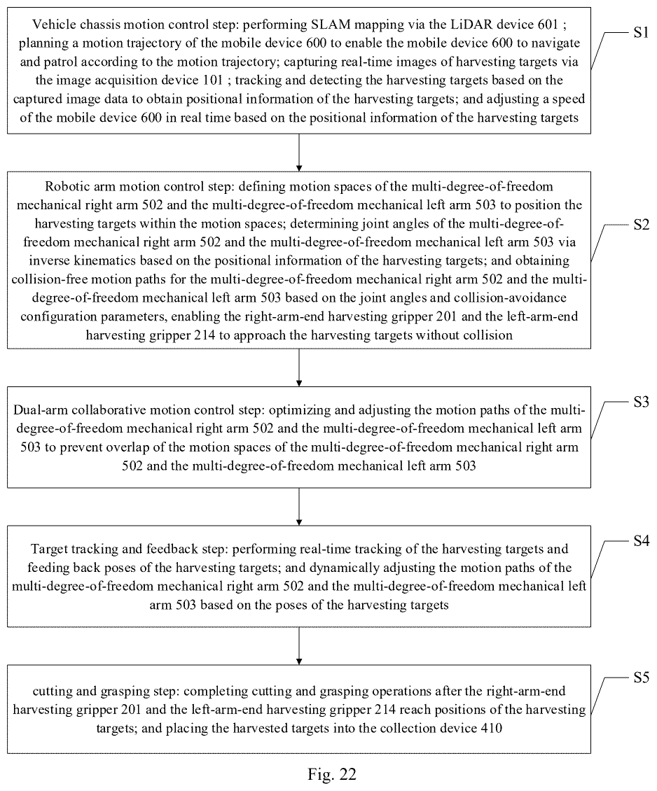

As shown in FIG. 21, the robot control device 700 comprises: a visual service device 701, a motion planning device 702, a robotic arm control device 703, a vehicle control device 704, a software communication device 705, a Python-AB-API device 706 and a natural language interaction device 707; the visual service device 701 is configured to capture scene image data via the image acquisition device 101, segment harvesting targets from the scene image data using a visual weighting model file, calculate 3D coordinate information of the harvesting targets, and detect and locate the harvesting targets; the motion planning device 702 is configured to plan motion paths for the multi-degree-of-freedom mechanical right arm 502 and the multi-degree-of-freedom mechanical left arm 503 based on the positional information of the harvesting targets and workspace configurations; the robotic arm control device 703 is configured to receive the motion paths from the motion planning device 702 and control the multi-degree-of-freedom mechanical right arm 502 and the multi-degree-of-freedom mechanical left arm 503 to execute harvesting along the motion paths; the vehicle control device 704 is configured to interact with the LiDAR device 601, the LiDAR device 601 performs SLAM mapping and navigation, and the vehicle control device 704 is configured to control operation of the mobile device 600; the software communication device 705 is configured to perform inter-device communication; the Python-AB-API device 706 is configured to invoke devices and/or receive information from the devices; and the natural language interaction device 707 is configured to implement human-machine interaction with the robot.

As shown in FIG. 22, this embodiment also provides a dual-arm harvesting robot control method, wherein the dual-arm harvesting robot control method is configured to control the dual-arm harvesting robot system, comprising following steps:
S1, vehicle chassis motion control step: performing SLAM mapping via the LiDAR device 601; planning a motion trajectory of the mobile device 600 to enable the mobile device 600 to navigate and patrol according to the motion trajectory; capturing real-time images of harvesting targets via the image acquisition device 101; tracking and detecting the harvesting targets based on the captured image data to obtain positional information of the harvesting targets; and adjusting a speed of the mobile device 600 in real time based on the positional information of the harvesting targets;
S2, robotic arm motion control step: defining motion spaces of the multi-degree-of-freedom mechanical right arm 502 and the multi-degree-of-freedom mechanical left arm 503 to position the harvesting targets within the motion spaces; determining joint angles of the multi-degree-of-freedom mechanical right arm 502 and the multi-degree-of-freedom mechanical left arm 503 via inverse kinematics based on the positional information of the harvesting targets; and obtaining collision-free motion paths for the multi-degree-of-freedom mechanical right arm 502 and the multi-degree-of-freedom mechanical left arm 503 based on the joint angles and collision-avoidance configuration parameters, enabling the right-arm-end harvesting gripper 201 and the left-arm-end harvesting gripper 214 to approach the harvesting targets without collision;
S3, dual-arm collaborative motion control step: optimizing and adjusting the motion paths of the multi-degree-of-freedom mechanical right arm 502 and the multi-degree-of-freedom mechanical left arm 503 to prevent overlap of the motion spaces of the multi-degree-of-freedom mechanical right arm 502 and the multi-degree-of-freedom mechanical left arm 503;
S4, target tracking and feedback step: performing real-time tracking of the harvesting targets and feeding back poses of the harvesting targets; and dynamically adjusting the motion paths of the multi-degree-of-freedom mechanical right arm 502 and the multi-degree-of-freedom mechanical left arm 503 based on the poses of the harvesting targets; and
S5, cutting and grasping step: completing cutting and grasping operations after the right-arm-end harvesting gripper 201 and the left-arm-end harvesting gripper 214 reach positions of the harvesting targets; and placing the harvested targets into the collection device 410.

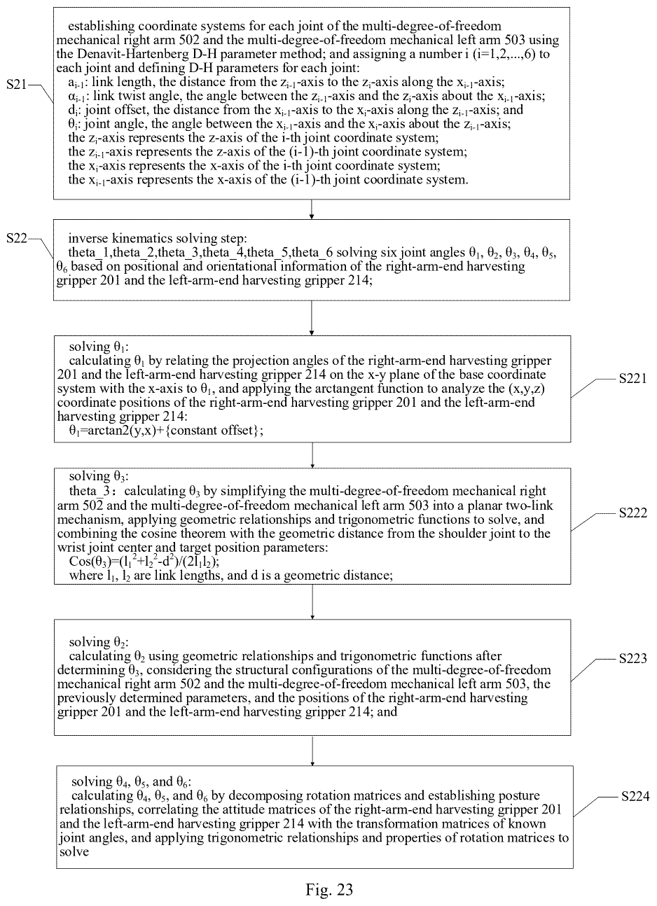

As shown in FIG. 23, the step of determining the joint angles of the multi-degree-of-freedom mechanical right arm 502 and the multi-degree-of-freedom mechanical left arm 503 via inverse kinematics specifically comprises following steps:
S21, robot model and coordinate system establishment step:
establishing coordinate systems for each joint of the multi-degree-of-freedom mechanical right arm 502 and the multi-degree-of-freedom mechanical left arm 503 using the Denavit-Hartenberg D-H parameter method; and assigning a number i (i=1, 2, . . . , 6) to each joint and defining D-H parameters for each joint:
a_{i−1}: link length, the distance from the z_{i−1}-axis to the z_i-axis along the x_{i−1}-axis;
α_{i−1}: link twist angle, the angle between the z_{i−1}-axis and the z_i-axis about the x_{i−1}-axis;
d_i: joint offset, the distance from the x_{i−1}-axis to the x_i-axis along the z_{i−1}-axis; and
θ_i: joint angle, the angle between the x_{i−1}-axis and the x_i-axis about the z_{i−1}-axis;
the z_i-axis represents the z-axis of the i-th joint coordinate system;
the z_{i−1}-axis represents the z-axis of the (i−1)-th joint coordinate system;
the x_i-axis represents the x-axis of the i-th joint coordinate system;
the x_{i−1}-axis represents the x-axis of the (i−1)-th joint coordinate system.

S22, inverse kinematics solving steps:
defining the pose transformation matrix from the base coordinate frame to the end-effector as T:

$$T = [ [ n\_x , o\_x , a\_x , p\_x ] , [ n\_y , o\_y , a\_y , p\_y ] , [ n\_z , o\_z , a\_z , p\_z ] , [ 0 , 0 , 0 , 1 ] ]$$

using the set values in the aforementioned matrix T as known values for inverse solution calculation in the following formulas:
adopting a human-robot collaborative robotic arm in the present disclosure, where adjacent joints 2, 3, and 4 at the shoulder, elbow, and wrist are parallel to each other, and noting that its inverse kinematics has a closed-form solution; based on the forward kinematics process, deriving the transformation matrix of joint 4 coordinate frame relative to joint 1 coordinate frame as follows:

$${T}_{14} = {T}_{12} {T}_{23} {T}_{34} = [ [ C 234 , - S 234 , 0 , C 2 + a\_ 3 C 23 ] , [ 0 , 0 , 1 , d\_ 4 ] , [ - S 234 , - C 234 , 0 , - a\_ 2 S 2 - a\_ 3 S 23 ] , [ 0 , 0 , 0 , 1 ] ]$$

$$C 234 = cos ( θ\_ 2 + θ\_ 3 + θ\_ 4 )$$

$$S 23 = sin ( θ\_ 2 + θ\_ 3 )$$

addressing the robotic arm with parallel joints 2, 3, and 4, and utiliz_i-ng the second row of T₁₄ being [0, 0, 1, d_4], the inverse kinematics process involves first obtaining the angles for joints 1, 5, and 6, and then solving for the angles of joints 2, 3, and 4;
solving for the angles of joints 1, 5, and 6:
based on T₁₄ and kinematic equation:

$${T}_{14} {T}_{45} = {T}_{12} {T}_{23} {T}_{34} {T}_{45} = {T}_{01}^{- 1} {T}_{06} {T}_{56}^{- 1}$$

wherein,

$${T}_{01}^{- 1} = [ [ C 1 , S 1 , 0 , 0 ] , [ - S 1 , C 1 , 0 , 0 ] , [ 0 , 0 , 1 , - d\_ 1 ] , [ 0 , 0 , 0 , 1 ] ]$$

$${T}_{06} = [ [ n\_x , o\_x , a\_x , p\_x ] , [ n\_y , o\_y , a\_y , p\_y ] , [ n\_z , o\_z , a\_z , p\_z ] , [ 0 , 0 , 0 , 1 ] ]$$

$${T}_{56}^{- 1} = [ [ C 6 , 0 , - S 6 , 0 ] , [ - S 6 , 0 , - C 6 , 0 ] , [ 0 , 1 , 0 , - d\_ 6 ] , [ 0 , 0 , 0 , 1 ] ]$$

$${T}_{45} = [ [ C 5 , - S 5 , 0 , 0 ] , [ 0 , 0 , - 1 , - d\_ 5 ] , [ S 5 , C 5 , 0 , 0 ] , [ 0 , 0 , 0 , 1 ] ]$$

expanding the matrix operations on both sides of the equation, and using the second row [0, 0, 1, d_4] of T₁₄, deriving the following equations from the elements of the second row of the expanded matrix:

$$[ S 5 , C 5 , 0 , d\_ 4 ] = [ - S 1 n\_x + C 1 n\_y , - S 1 o\_x + C 1 o\_y , - S 1 a\_x + C 1 a\_y , - S 1 p\_x + C 1 p\_y ] [ [ C 6 , 0 , - S 6 , 0 ] , [ - S 6 , 0 , - C 6 , 0 ] , [ 0 , 1 , 0 , - d\_ 6 ] , [ 0 , 0 , 0 , 1 ] ]$$

establishing four equations based on the above formula as follows:

$$d\_ 4 = - d\_ 6 ( - S 1 a\_x + C 1 a\_y ) - S 1 p\_x + C 1 p\_y ;$$

$$C 5 = - S 1 a\_x + C 1 a\_y ;$$

$$S 5 = ( - S 1 n\_x + C 1 n\_y ) C 6 - ( - S 1 o\_x + C 1 o\_y ) S 6 ;$$

$$0 = - ( - S 1 n\_x + C 1 n\_y ) S 6 - ( - S 1 o\_x + C 1 o\_y ) C 6$$

solving for joint 1 angle from the first equation:

$$C 1 ( a\_y d\_ 6 - p\_y ) - S 1 ( a\_x d\_ 6 - p\_x ) = - d\_ 4 ;$$

$$letting : m = a\_y d\_ 6 - p\_y , n = a\_x d\_ 6 - p\_x , then :$$

$$θ\_ 1 = arc tan 2 ( m , n ) - arc tan 2 ( - d\_ 4 , \sqrt{{m}^{2} + {n}^{2} - d\_ {4}^{2}} ) or ,$$

$$θ\_ 1 = arc tan 2 ( m , n ) - arc tan 2 ( - d\_ 4 , - \sqrt{{m}^{2} + {n}^{2} - d\_ {4}^{2}} )$$

solving for joint 5 angle from the second equation:

$$θ\_ 5 = arc cos ( - S 1 a\_x + C 1 a\_y ) or ,$$

$$θ\_ 5 = - arc cos ( - S 1 a\_x + C 1 a\_y )$$

solving for joint 6 angle from the third and fourth equations: letting: —S1n_x+C1n_y=m1, —S1o_x+C1o_y=n1, then:

$$S 5 = m 1 C 6 - n 1 S 6$$

$$0 = m 1 S 6 + n 1 C 6$$

$$solving gives : S 6 = - n 1 / S 5 , C 6 = m 1 / S 5$$

$$θ\_ 6 = arc tan 2 ( - n 1 / S 5 , m 1 / S 5 ) or θ\_ 6 = arc tan ( - n 1 / m 1 )$$

solving for the angles of joints 2, 3, and 4:
using the equation: T₁₄ T₄₅=T₁₂T₂₃T₃₄T₄₅=T₀₁⁻¹T₀₆T₅₆⁻¹

$${T}_{14} = {T}_{01}^{- 1} {T}_{06} {{T}_{56}^{- 1} ( {T}_{45} )}^{- 1} = [ [ C 234 , - S 234 , 0 , C 2 a\_ 2 + a\_ 3 C 23 ] , [ 0 , 0 , 1 , d\_ 4 ] , [ - S 234 , - C 234 , 0 , - a\_ 2 S 2 - a\_ 3 S 23 ] , [ 0 , 0 , 0 , 1 ] ]$$

given that θ_1, θ_5, and θ_6 are known, then:
all elements in T₀₁⁻¹T₀₆T₅₆⁻¹T₄₅⁻¹=T₁₄ are known quantities; letting x=T₁₄(1,4), denoting the element in the first row and fourth column of the matrix; letting y=T₁₄(3,4), denoting the element in the third row and fourth column, therefore:

$$C 2 a\_ 2 + a\_ 3 C 23 = x ;$$

$$a\_ 2 S 2 + a\_ 3 S 23 = - y ;$$

$$deriving : a\_ {2}^{2} + a\_ {3}^{2} + 2 a\_ 2 a\_ 3 ( C 23 C 2 + S 23 S 2 ) = {x}^{2} + {y}^{2} = a\_ {2}^{2} + a\_ {3}^{2} + 2 a\_ 2 a\_ 3 C 3 ;$$

$$θ\_ 3 = arc cos ( \frac{x \hat{} 2 + y \hat{} 2 - a\_ 2 \hat{} 2 - a\_ 3 \hat{} 2}{2 a\_ 2 a\_ 3} )$$

transforming the compound angle formulas into single angles from the equations for x and y:

$$x = ( a\_ 3 C 3 + a\_ 2 ) C 2 - a\_ 3 S 3 S 2$$

$$- y = a\_ 3 S 3 C 2 + ( a\_ 3 C 3 + a\_ 2 ) S 2$$

solving the system of equations for C2 and S2:

$$[ C 2 S 2 ] = [ [ a\_ 3 C 3 + a\_ 2 - a\_ 3 S 3 ] , [ a\_ 3 S 3 a\_ 3 C 3 + a 2 ] ] [ x - y ]$$

$$therefore : θ\_ 2 = arc tan 2 ( S 2 , C 2 )$$

using the expansion of the T₁₄ matrix:

$$C 234 = {T}_{14} ( 1 , 1 )$$

$$- S 234 = {T}_{14} ( 1 , 2 )$$

solving for joint 4:

$$θ\_ 4 = arc tan 2 ( - {T}_{14} ( 1 , 2 ) , {T}_{14} ( 1 , 1 ) ) - θ\_ 2 - θ\_ 3$$

completing the solution for all six angles θ_1, θ_2, θ_3, θ_4, θ_5, and θ_6.

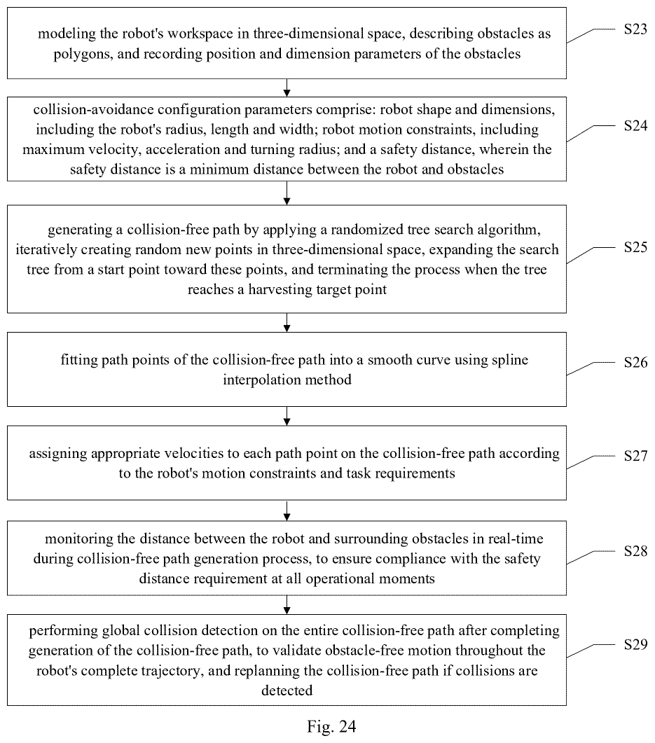

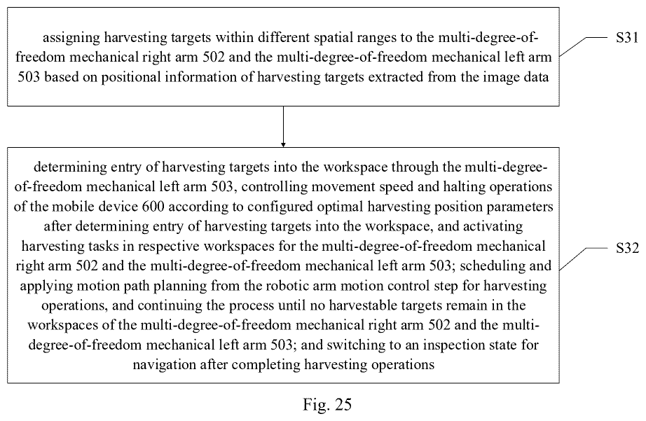

As shown in FIG. 24, the step of obtaining collision-free motion paths for the multi-degree-of-freedom mechanical right arm 502 and the multi-degree-of-freedom mechanical left arm 503 specifically comprises following steps:
S23, modeling the robot's workspace in three-dimensional space, describing obstacles as polygons, and recording position and dimension parameters of the obstacles;
S24, collision-avoidance configuration parameters comprise: robot shape and dimensions, including the robot's radius, length and width; robot motion constraints, including maximum velocity, acceleration and turning radius; and a safety distance, wherein the safety distance is a minimum distance between the robot and obstacles;
S25, generating a collision-free path by applying a randomized tree search algorithm, iteratively creating random new points in three-dimensional space, expanding the search tree from a start point toward these points, and terminating the process when the tree reaches a harvesting target point;
S26, fitting path points of the collision-free path into a smooth curve using spline interpolation method;
S27, assigning appropriate velocities to each path point on the collision-free path according to the robot's motion constraints and task requirements;
S28, monitoring the distance between the robot and surrounding obstacles in real-time during collision-free path generation process, to ensure compliance with the safety distance requirement at all operational moments; and
S29, performing global collision detection on the entire collision-free path after completing generation of the collision-free path, to validate obstacle-free motion throughout the robot's complete trajectory, and replanning the collision-free path if collisions are detected.

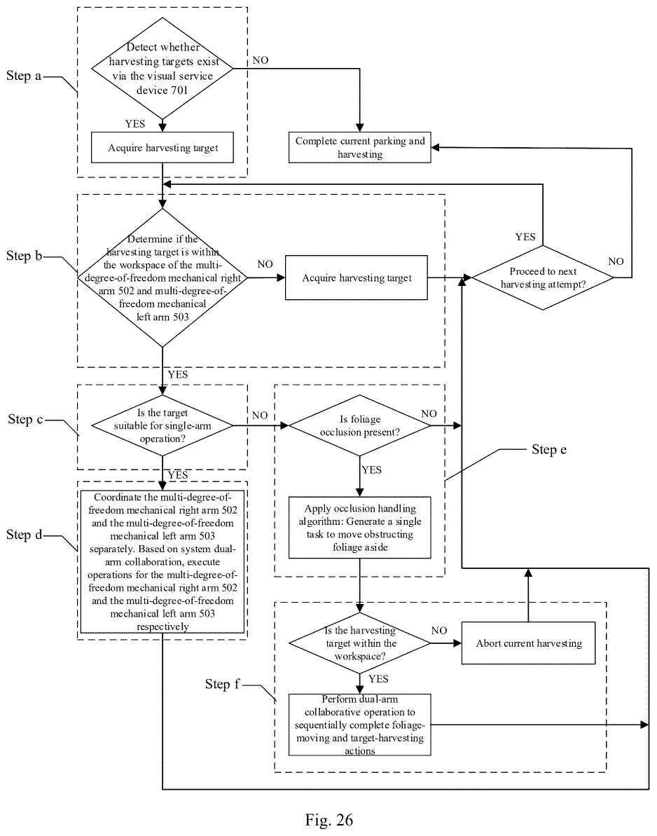

As shown in FIG. 26, the dual-arm collaborative motion control step comprises:
S31, assigning harvesting targets within different spatial ranges to the multi-degree-of-freedom mechanical right arm 502 and the multi-degree-of-freedom mechanical left arm 503 based on positional information of harvesting targets extracted from the image data; and
S32, determining entry of harvesting targets into the workspace through the multi-degree-of-freedom mechanical left arm 503, controlling movement speed and halting operations of the mobile device 600 according to configured optimal harvesting position parameters after determining entry of harvesting targets into the workspace, and activating harvesting tasks in respective workspaces for the multi-degree-of-freedom mechanical right arm 502 and the multi-degree-of-freedom mechanical left arm 503; scheduling and applying motion path planning from the robotic arm motion control step for harvesting operations, and continuing the process until no harvestable targets remain in the workspaces of the multi-degree-of-freedom mechanical right arm 502 and the multi-degree-of-freedom mechanical left arm 503; and switching to an inspection state for navigation after completing harvesting operations.

As shown in FIGS. 10 and 26, the safety collaborative motion rules for the multi-degree-of-freedom mechanical right arm 502 and the multi-degree-of-freedom mechanical left arm 503 are as follows:
Step a, detect whether a harvesting target exists via the visual service device 701; if yes, perform collection of the harvesting target; if no, complete the current parking harvesting;
Step b, after detecting the harvesting target, determine whether the harvesting target is within the working space of the multi-degree-of-freedom mechanical right arm 502 and multi-degree-of-freedom mechanical left arm 503; if yes, proceed to Step c; if no, abandon the current harvesting and determine whether to perform the next harvesting;
Step c, determine whether single-arm operation is suitable; if yes, proceed to Step d; if no, proceed to Step e;
Step d, respectively dispatch the multi-degree-of-freedom mechanical right arm 502 and the multi-degree-of-freedom mechanical left arm 503; based on system dual-arm coordination, perform operations of the multi-degree-of-freedom mechanical right arm 502 and operations of the multi-degree-of-freedom mechanical left arm 503; then determine whether to perform the next harvesting;
Step e, determine whether leaf occlusion exists; if yes, process the occlusion using an occlusion handling algorithm, specifically: generate an operation task of pushing away the leaves once, then proceed to Step f; if no, abandon the current harvesting and determine whether to perform the next harvesting; and
Step f, determine whether the harvesting target is within the working space; if yes, perform dual-arm collaborative operations, sequentially complete the leaf-pushing action and the harvesting target action; after completion, determine whether to perform the next harvesting; if no, abandon the current harvesting and determine whether to perform the next harvesting.

Determine whether to perform the next harvesting; if yes, restart Step b; if no, complete the current parking harvesting.

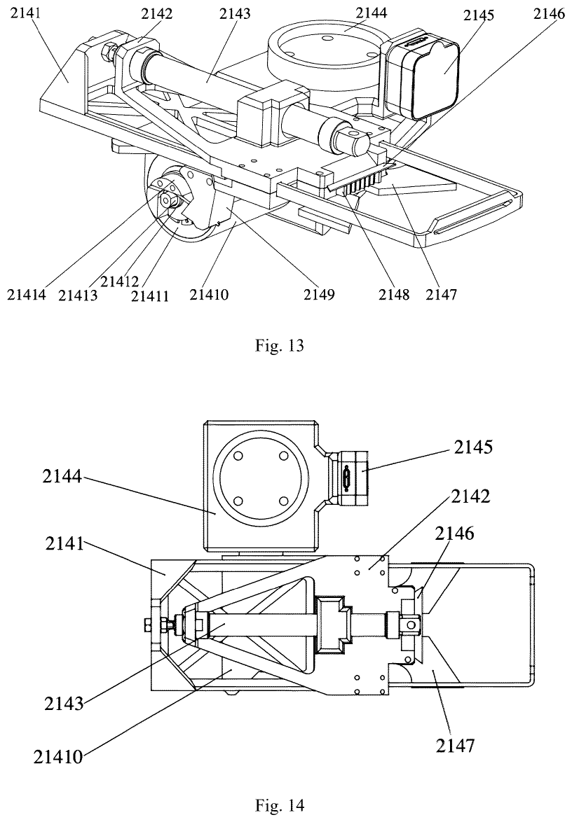

As shown in FIGS. 13 and 14, the left-arm-end harvesting gripper 214 comprises: a finger component 2141, a rail upper cover 2142, a pneumatic cylinder 2143, a side-mounted flange frame 2144, a vision camera 2145, a blade 2146, a fruit stem guide 2147, a fruit stem clamping component 2148, a pitch torsion spring follower 2149, a rail lower cover 21410, a bearing 21411, a torsion spring 21412, a torsion spring center fixation component 21413, and a torsion spring short-arm fixation component 21414.

Among these, the bearing 21411 is transition-fitted with the rail lower cover 21410. The bearing 21411 and rail lower cover 21410 are then inserted into the feature shaft of the side-mounted flange frame 2144, and an axial elastic retaining ring constrains the axial movement of the rail lower cover 21410 and bearing 21411. The vision camera 2145 is thread-connected to the side-mounted flange frame. The cylinder body of the pneumatic cylinder 2143 is thread-connected to the rail upper cover 2142. The finger component 2141 is thread-connected to the piston rod of the pneumatic cylinder 2143. The rail upper cover 2142 and the rail lower cover 21410 are thread-connected. The finger component forms a sliding pair between the rail upper cover and the rail lower cover. The fruit stem guide 2147 is thread-connected to the rail upper cover 2142. The blade 2146 and the fruit stem clamping component 2148 are clamped between the rail upper cover 2142 and fruit stem guide 2147. The pitch torsion spring follower 2149 is thread-connected to the rail lower cover 21410. The torsion spring center fixation component 21413 is thread-connected to the rail lower cover 21410. The torsion spring short-arm fixation component 21414 is thread-connected to the rail lower cover 21410. The long arm of the torsion spring 21412 is inserted into the torsion spring hole of the pitch torsion spring follower 2149. The large diameter of the torsion spring 21412 is sleeved onto the torsion spring center fixation component 21413, and the short arm is engaged into the gap formed between the rail lower cover 21410 and the torsion spring short-arm fixation component 21414.

In this embodiment, when the front end of the finger component 2141 contacts the fruit stem and receives downward tilting force, the cutting surface of the finger component 2141 becomes perpendicular to the fruit stem for cutting. Through cooperation between the torsion spring 21412 and the angled torsion spring hole in the pitch torsion spring follower 2149, the entire assembly maintains a horizontal position when not under force.

The working process of the left-arm-end harvesting gripper 214 in this embodiment is as follows: After the vision camera 2145 identifies clustered tomato fruits, the robotic arm extends the end effector to the base of the clustered tomatoes. The front square cutout of the finger component 2141 aligns with the base of the clustered tomatoes, and the end effector lifts upward until the front edge of the finger component 2141 contacts the fruit stem. The front end tilts downward under tangential force until the front plane becomes perpendicular to the fruit stem. The piston rod of the pneumatic cylinder 2143 extends, causing the finger component and the blade 2146 to clamp and sever the fruit stem. The upper portion of the fruit stem is discharged through the front inclined surface of the rail upper cover 2142, while the lower portion of the fruit stem is clamped by the fruit stem clamping component 2148 and the finger component 2141, thereby completing the integrated clipping and clamping of the clustered tomatoes.

### Embodiment 2

Those skilled in the art may interpret this embodiment as a more detailed elaboration of Embodiment 1.

This embodiment provides a dual-arm harvesting robot system, comprising: an image acquisition device 101, a neck rotating joint 102, a right-arm-end harvesting gripper 201, a sixth right arm joint 202, a fifth right arm joint 203, a fourth right arm joint 204, a third right arm joint 205, a second right arm joint 206, a first right arm joint 207, a first left arm joint 208, a second left arm joint 209, a third left arm joint 210, a fourth left arm joint 211, a fifth left arm joint 212, a sixth left arm joint 213, a left-arm-end harvesting gripper 214, a waist rotating joint 301, a first waist lifting joint 302, a second waist lifting joint 303, a rear LiDAR 401, a rear anti-collision strip 402, a rear chassis track wheel 403, a rear chassis caster wheel 404, a chassis drive wheel 405, a front chassis track wheel 406, a front chassis caster wheel 407, a front anti-collision strip 408, a front LiDAR 409, a collection device 410, and a mobile chassis 411.

The dual-arm harvesting robot system in this embodiment primarily involves the following components:

### 1. Robot Body

The robot body 500 comprises a mobile chassis, a rotating and lifting waist-hip joint, dual 6×2-degree-of-freedom mechanical arms, and a 3-joint harvesting mechanical wrist, forming an 18-degree-of-freedom harvesting robot body 500. As shown in FIG. 1, this represents an anthropomorphic multi-joint tomato-harvesting robot system enhanced with the rotating and lifting waist-hip joint.

### (1) Head-Eye Assembly

A depth camera D435 (101) is embedded in the eye position of the humanoid robot head to observe the environment over a wide range, intelligently recognize diverse objects in the environment, enable global path planning, and improve task reception and execution capabilities through environmental intelligence. As shown in FIG. 2, this represents the robot head-mounted camera.

### (2) Mobile Chassis

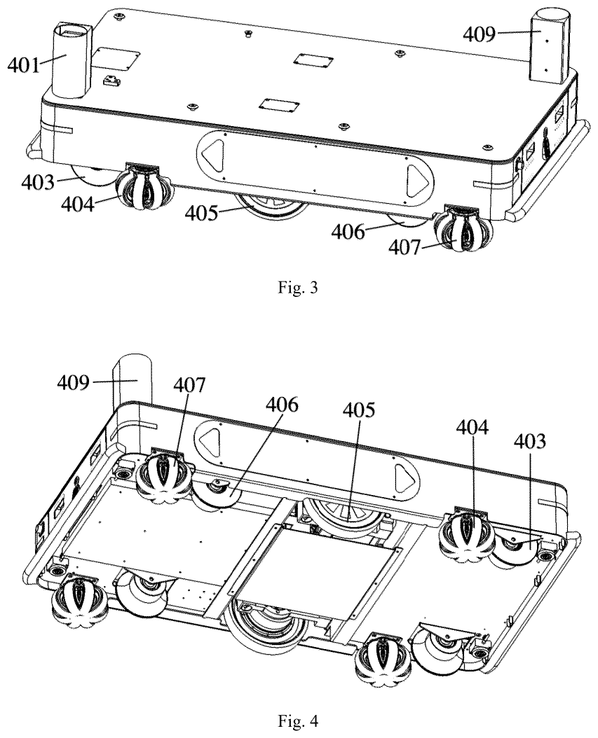

To align with the linear rail-based cultivation characteristics of facility-grown tomatoes, the mobile chassis replaces humanoid bipedal legs to achieve high-speed movement, stable gait, and precise linear motion. As shown in FIG. 3, the chassis is mounted on rails. The robot chassis includes: a rear LiDAR 401, a rear anti-collision strip 402, a rear chassis track wheel 403, a rear chassis caster wheel 404, a chassis drive wheel 405, a front chassis track wheel 406, a front chassis caster wheel 407, a front anti-collision strip 408, and a front LiDAR 409. LiDAR-based SLAM mapping and navigation control the dual-wheel differential chassis to automate rail mounting/dismounting and rail switching. FIGS. 3 and 4 illustrate the robot mobile chassis.

### (3) Waist-Hip Rotation

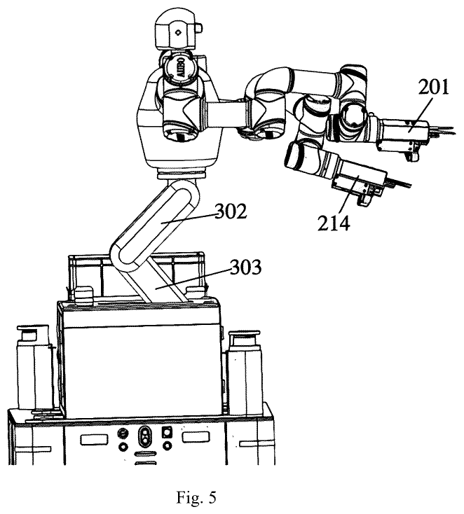

Based on tomato planting characteristics such as multi-ridge dense planting and double-row opposite planting along a single track, the harvesting robot is required to achieve dual-row harvesting while traveling along a single track. The robot body incorporates a waist rotating joint 301 that controls the torso to rotate ±180°, enabling multi-row harvesting on a single track. FIG. 5 illustrates the waist rotating joint.

### (4) Upper Limb Lifting Joint

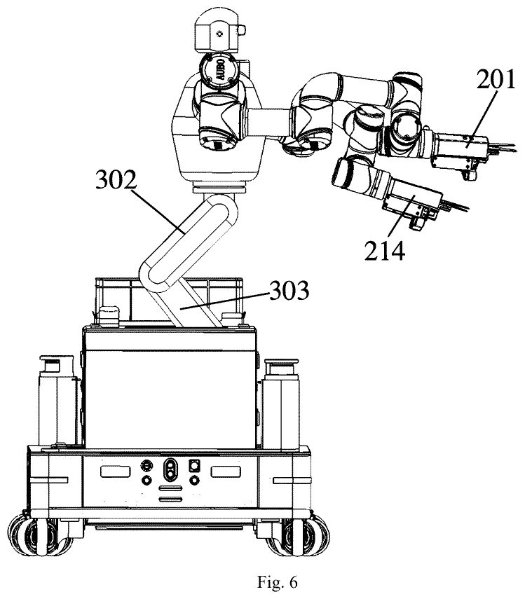

Given tomato growth heights ranging from 0.3-4.0 m and human ergonomic harvesting zones between 0.4-1.4 m, a hip-mounted upper limb folding lift joint adjusts the robot's arm span height to enhance stability. A motor-driven lifting mechanism extends the harvesting height range. FIG. 6 shows the upper limb folding lift joint.

### (5) Robot Arm

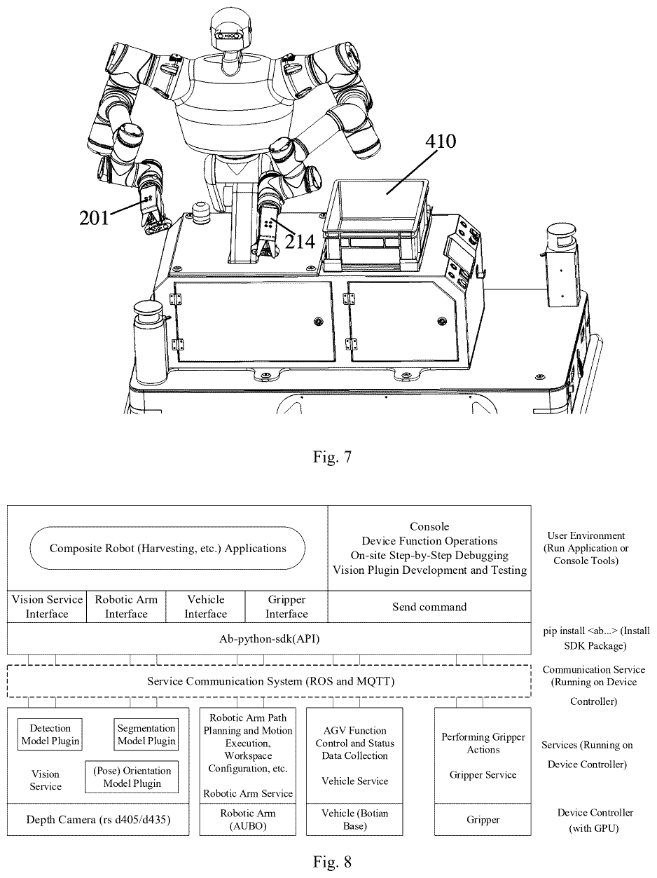

Two independent 6-axis collaborative robotic arms are included. A 6-axis collaborative right robotic arm is formed by a sixth right arm joint 202, a fifth right arm joint 203, a fourth right arm joint 204, a third right arm joint 205, a second right arm joint 206, and a first right arm joint 207. A 6-axis collaborative left robotic arm is formed by a first left arm joint 208, a second left arm joint 209, a third left arm joint 210, a fourth left arm joint 211, a fifth left arm joint 212 and a sixth left arm joint 213. Each robotic arm consists of six independent joints, enabling 6 degrees of freedom (DOF) motion. The right-arm-end harvesting gripper 201 and the left-arm-end harvesting gripper 214 enable targeted grasping of fruits and vegetables. FIG. 7 demonstrates dual-arm harvesting.

Eye-in-Hand Configuration: Mounted on one arm, specifically configured at the end of the left arm, is a depth vision camera D405 for detecting and locating harvesting targets.

### 2. Software Platform and Architecture

The humanoid harvesting robot is a complex system. From a software control perspective, the system comprises two major categories of motion actuators: a mobile chassis capable of autonomous navigation movement and dual arms for task execution. Simultaneously, dual-arm harvesting operations rely on depth camera-based visual guidance, forming a core visual service system. These three components constitute the primary controlled entities and functional applications of the harvesting system, representing the main objectives of the control software.

Fundamentally, the software system of the humanoid harvesting robot is a robotic control system. ROS (Robot Operating System) is currently a widely adopted robotic control framework. ROS manages and transmits multi-sensor data from cameras, robotic arms, LiDAR, the chassis, etc. All these components are defined as device nodes that communicate by subscribing to relevant topics. As a result, ROS inherently provides an excellent device system architecture. Leveraging the ROS ecosystem, mature modules for autonomous navigation of the mobile chassis and motion control of robotic arms are readily available for reference. Its plugin mechanism also offers substantial flexibility for optimization and expansion. Therefore, the humanoid robot system architecturally integrates ROS for autonomous navigation of the mobile chassis and motion control of the dual humanoid arms. However, to address real-time visual processing efficiency, the depth camera used for target recognition and localization within the visual service framework does not utilize ROS node-based communication. Instead, the depth camera's low-level API directly captures image/video streams, extracts image frames from the data stream, performs spatial alignment of 2D images with depth information frames, executes inference via a YOLO detection module, and exchanges result data with applications through MQTT.

Furthermore, compared to traditional robots, intelligent humanoid robots must possess environmental cognitive capabilities and more advanced human interaction methods. Therefore, at the application layer, the Ollama large language model is integrated as the AI platform to enable natural language interaction for human-robot collaboration in harvesting tasks. The specific architectural implementation is illustrated in FIG. 8.

### (1) Visual Service Device 701

The visual service device 701 utilizes a depth camera installed on the end effector to acquire images for detecting and localizing clustered tomatoes. The visual service device 701 captures on-site scenes with the depth camera and segments target cutting objects using the visual weight model files. Subsequently, the visual service device 701 calculates 3D coordinates of the targets and publishes this data through public topics.

### (2) Motion Planning Device 702

The motion planning device 702 functions as a Movelt control node, planning robotic arm harvesting trajectories based on target information and workspace configurations.

### (3) Robotic Arm Control Device 703

The robotic arm control device 703 comprises two ROS node instances that receive motion trajectories from the motion planning device 702 and independently control the left/right robotic arms to execute the paths.

### (4) Vehicle Control Device 704

The vehicle control device 704 is configured for interacting with the chassis ROS navigation device nodes.

### (5) Software Communication Device 705

Among all devices, some operate as ROS nodes. However, for visual processing efficiency, the visual service device 701 does not use a ROS node driver; instead, the visual service device 701 directly reads and processes images to perform inference. Communication between these devices is facilitated both via ROS topic-based communication among nodes within the ROS domain and through MQTT communication services. A unified SDK API is provided at the application level for calling and using these devices.

### (6) Python-AB-API

The Python-AB-API is uniformly utilized by the harvesting application for function invocation or for receiving information from the devices. For example, on one hand, the application subscribes to vision service topics via the API interface to obtain target tomato localization data; on the other hand, it issues motion planning requests to the motion planning device 702 through the API and ultimately drives the robotic arm to move to target positions via the robotic arm control device 703 to execute harvesting actions.

### (7) Natural Language Interaction Device 707

The natural language interaction device 707 uses the open-source large language model Ollama as the platform to establish a local knowledge base for the harvesting robot system. By uniformly integrating relevant information into the large language model, this integration facilitates more convenient retrieval, querying, and utilization. More importantly, the natural language interaction device 707 enables the connection between the harvesting robot's API and Ollama, allowing system control and invocation through a universal natural language interaction UI.

### 3. Robotic Control System

In the mobile composite robotic control system, the motion control device is one of the most crucial core devices. It utilizes vision service processing to obtain target position data, plans dual-arm grasping or cutting actions, and coordinates the entire motion control process, which becomes more complex due to being mounted on a mobile chassis. Overall, the following four components collaborate to accomplish harvesting tasks.

### (1) Vehicle Chassis Motion Control

Based on visual target tracking and detection, the system performs real-time adjustment of control speeds and precise real-time control of chassis movement and harvesting.

The implementation of this control strategy relies on real-time target detection. When detecting that the primary target approaches the working space, the system requires deceleration control based on the target's proximity to the optimal position within the working space i.e., slightly rearward from the central position.

### (2) Robotic Arm Motion Control

First, the robotic arm's motion space is defined to ensure the harvesting target resides within the working space. This process is divided into two sequential steps to generate a safe harvesting path: first, joint angles are calculated via inverse kinematics based on the target position; then, the required collision-free motion trajectory is acquired using collision-avoidance configuration parameters, ensuring the end effector effectively approaches the localized target in an optimized and obstacle-free manner.

Inverse kinematics solving joint angle:
a, robot model and coordinate system establishment step:
establishing coordinate systems for each joint using the Denavit-Hartenberg (D-H) parameter method; and assigning a number i (i=1, 2, . . . , 6) to each joint and defining D-H parameters for each joint:
1) a_{i−1}: link length, the distance from the z_{i−1}-axis to the z_i-axis along the x_{i−1}-axis;
2) a_{i−1}: link twist angle, the angle between the z_{i−1}-axis and the z_i-axis about the x_{i−1}-axis;
3) d_i: joint offset, the distance from the x_{i−1}-axis to the x_i-axis along the z_{i−1}-axis;
4) θ_i: joint angle, the angle between the x_{i−1}-axis and the x_i-axis about the z_{i−1}-axis.
b, inverse kinematics solving steps:
defining the pose transformation matrix from the base coordinate frame to the end-effector as T:

$$T = [ [ n\_x , o\_x , a\_x , p\_x ] , [ n\_y , o\_y , a\_y , p\_y ] , [ n\_z , o\_z , a\_z , p\_z ] , [ 0 , 0 , 0 , 1 ] ]$$

using the set values in the aforementioned matrix T as known values for inverse solution calculation in the following formulas:
adopting a human-robot collaborative robotic arm in the present disclosure, where adjacent joints 2, 3, and 4 at the shoulder, elbow, and wrist are parallel to each other, and noting that its inverse kinematics has a closed-form solution; based on the forward kinematics process, deriving the transformation matrix of joint 4 coordinate frame relative to joint 1 coordinate frame as follows:

$${T}_{14} = {T}_{12} {T}_{23} {T}_{34} = [ C 234 , - S 234 , 0 , C 2 + a\_ 3 C 23 ] , [ 0 , 0 , 1 , d\_ 4 ] , [ - S 234 , - C 234 , 0 , - a\_ 2 S 2 - a\_ 3 S 23 ] , [ 0 , 0 , 0 , 1 ] ]$$

$$C 234 = cos ( θ\_ 2 + θ\_ 3 + θ\_ 4 )$$

$$S 23 = sin ( θ\_ 2 + θ\_ 3 )$$

addressing the robotic arm with parallel joints 2, 3, and 4, and utilizing the second row of T₁₄ being [0, 0, 1, d_4], the inverse kinematics process involves first obtaining the angles for joints 1, 5, and 6, and then solving for the angles of joints 2, 3, and 4;
solving for the angles of joints 1, 5, and 6:
based on T₁₄ and kinematic equation:

$${T}_{14} {T}_{45} = {T}_{12} {T}_{23} {T}_{34} {T}_{45} = {T}_{01}^{- 1} {T}_{06} {T}_{56}^{- 1}$$

wherein,

$${T}_{01}^{- 1} = [ [ C 1 , S 1 , 0 , 0 ] , [ - S 1 , C 1 , 0 , 0 ] , [ 0 , 0 , 1 , - d\_ 1 ] , [ 0 , 0 , 0 , 1 ] ]$$

$${T}_{06} = [ [ n\_x , o\_x , a\_x , p\_x ] , [ n\_y , o\_y , a\_y , p\_y ] , [ n\_z , o\_z , a\_z , p\_z ] , [ 0 , 0 , 0 , 1 ] ]$$

$${T}_{56}^{- 1} = [ [ C 6 , 0 , - S 6 , 0 ] , [ - S 6 , 0 , - C 6 , 0 ] , [ 0 , 1 , 0 , - d\_ 6 ] , [ 0 , 0 , 0 , 1 ] ]$$

$${T}_{45} = [ [ C 5 , - S 5 , 0 , 0 ] , [ 0 , 0 , - 1 , - d\_ 5 ] , [ S 5 , C 5 , 0 , 0 ] , [ 0 , 0 , 0 , 1 ] ]$$

expanding the matrix operations on both sides of the equation, and using the second row [0, 0, 1, d_4] of T₁₄, deriving the following equations from the elements of the second row of the expanded matrix:

$$[ S 5 , C 5 , 0 , d\_ 4 ] = [ - S 1 n\_x + C 1 n\_y , - S 1 o\_x + C 1 o\_y , - S 1 a\_x + C 1 a\_y , - S 1 p\_x + C 1 p\_y ] [ [ C 6 , 0 , - S 6 , 0 ] , [ - S 6 , 0 , - C 6 , 0 ] , [ 0 , 1 , 0 , - d\_ 6 ] , [ 0 , 0 , 0 , 1 ] ]$$

establishing four equations based on the above formula as follows:

$$d\_ 4 = - d\_ 6 ( - S 1 a\_x + C 1 a\_y ) - S 1 p\_x + C 1 p\_y ;$$

$$C 5 = - S 1 a\_x + C 1 a\_y ;$$

$$S 5 = ( - S 1 n\_x + C 1 n\_y ) C 6 - ( - S 1 o\_x + C 1 o\_y ) S 6 ;$$

$$0 = - ( - S 1 n\_x + C 1 n\_y ) S 6 - ( - S 1 o\_x + C 1 o\_y ) C 6$$

solving for joint 1 angle from the first equation:

$$C 1 ( a\_y d\_ 6 - p\_y ) - S 1 ( a\_x d\_ 6 - p\_x ) = - d\_ 4 ;$$

$$letting : m = a\_y d\_ 6 - p\_y , n = a\_x d\_ 6 - p\_x , then :$$

$$θ\_ 1 = arc tan 2 ( m , n ) - arc tan 2 ( - d\_ 4 , \sqrt{{m}^{2} + {n}^{2} - d\_ {4}^{2}} ) or ,$$

$$θ\_ 1 = arc tan 2 ( m , n ) - arc tan 2 ( - d\_ 4 , - \sqrt{{m}^{2} + {n}^{2} - d\_ {4}^{2}} )$$

solving for joint 5 angle from the second equation:

$$θ\_ 5 = arc cos ( - S 1 a\_x + C 1 a\_y ) or ,$$

$$θ\_ 5 = - arc cos ( - S 1 a\_x + C 1 a\_y )$$

solving for joint 6 angle from the third and fourth equations: letting: —S1n_x+C1n_y=m1, −S1o_x+C1o_y=n1, then:

$$S 5 = m 1 C 6 - n 1 S 6$$

$$0 = m 1 S 6 + n 1 C 6$$

$$solving gives : S 6 = - n 1 / S 5 , C 6 = m 1 / S 5$$

$$θ\_ 6 = arc tan 2 ( - n 1 / S 5 , m 1 / S 5 ) or θ\_ 6 = arc tan ( - n 1 / m 1 )$$

solving for the angles of joints 2, 3, and 4:
using the equation: T₁₄T₄₅=T₁₂T₂₃T₃₄T₄₅=T₀₁⁻¹T₀₆T₅₆⁻¹

$${T}_{14} = {T}_{01}^{- 1} {T}_{06} {{T}_{56}^{- 1} ( {T}_{45} )}^{- 1} = [ [ C 234 , - S 234 , 0 , C 2 a\_ 2 + a\_ 3 C 23 ] , [ 0 , 0 , 1 , d\_ 4 ] , [ - S 234 , - C 234 , 0 , - a\_ 2 S 2 - a\_ 3 S 23 ] , [ 0 , 0 , 0 , 1 ] ]$$

given that θ_1, θ_5, and θ_6 are known, then:
all elements in T₀₁⁻¹T₀₆T₅₆⁻¹T₄₅⁻¹=T₁₄ are known quantities; letting x=T₁₄(1,4), denoting the element in the first row and fourth column of the matrix; letting y=T₁₄(3,4), denoting the element in the third row and fourth column, therefore:

$$C 2 a\_ 2 + a\_ 3 C 23 = x ;$$

$$a\_ 2 S 2 + a\_ 3 S 23 = - y ;$$

$$deriving : a\_ {2}^{2} + a\_ {3}^{2} + 2 a\_ 2 a\_ 3 ( C 23 C 2 + S 23 S 2 ) = {x}^{2} + {y}^{2} = a\_ {2}^{2} + a\_ {3}^{2} + 2 a\_ 2 a\_ 3 C 3 ;$$

$$θ\_ 3 = arc cos ( \frac{x \hat{} 2 + y \hat{} 2 - a\_ 2 \hat{} 2 - a\_ 3 \hat{} 2}{2 a\_ 2 a\_ 3} )$$

transforming the compound angle formulas into single angles from the equations for x and y:

$$x = ( a\_ 3 C 3 + a\_ 2 ) C 2 - a\_ 3 S 3 S 2$$

$$- y = a\_ 3 S 3 C 2 + ( a\_ 3 C 3 + a\_ 2 ) S 2$$

solving the system of equations for C2 and S2:

$$[ C 2 S 2 ] = [ [ a\_ 3 C 3 + a\_ 2 - a\_ 3 S 3 ] , [ a\_ 3 S 3 a\_ 3 C 3 + a 2 ] ] [ x - y ]$$

$$therefore : θ\_ 2 = arc tan 2 ( S 2 , C 2 )$$

using the expansion of the T₁₄ matrix:

$$C 234 = {T}_{14} ( 1 , 1 )$$

$$- S 234 = {T}_{14} ( 1 , 2 )$$

solving for joint 4.

$$θ\_ 4 = arc tan 2 ( - {T}_{14} ( 1 , 2 ) , {T}_{14} ( 1 , 1 ) ) - θ\_ 2 - θ\_ 3$$

completing the solution for all six angles θ_1, θ_2, θ_3, θ_4, θ_5, and θ_6.

### Collision-Avoidance Motion Trajectory Planning

The required motion trajectory is calculated based on collision-avoidance configuration parameters, which is a critical task to ensure the robot avoids collisions with surrounding obstacles while moving from the starting point to the target. The detailed process is as follows:

a. Environment Modeling and Parameter Definition

Environment Modeling: Modeling the robot's workspace in three-dimensional space, describing obstacles as polygons, and recording position and dimension parameters of the obstacles.

Collision-Avoidance Configuration Parameters: robot shape and dimensions, including the robot's radius, length and width; robot motion constraints, including maximum velocity, acceleration and turning radius; and a safety distance, wherein the safety distance is a minimum distance between the robot and obstacles.

b. Rapidly-Exploring Random Tree RRT Path Search Algorithm

Starting from the initial point, the algorithm iteratively generates random new points and expands the tree toward these points until the tree includes the target point or identifies a collision-free path.

c. Trajectory Optimization

Smoothing: The initial path obtained from the search may exhibit discontinuities or excessive curvature. Smoothing is applied using spline curve fitting to transform path points into a continuous curve, ensuring fluid robot motion.

Velocity Planning: Assigning appropriate velocities to each trajectory point according to the robot's motion constraints and task requirements to guarantee safety and stability.

d. Combined Local and Global Collision Detection

Local Collision Detection: Monitoring the distance between the robot and surrounding obstacles in real-time during trajectory generation, to ensure compliance with the safety distance requirement at all operational moments.

Global Collision Detection: Performing global collision detection on the entire trajectory after completing generation of the trajectory, to validate obstacle-free motion throughout the robot's complete trajectory, and replanning the trajectory if collisions are detected.

### Dual-Arm Collaborative Motion Mechanism

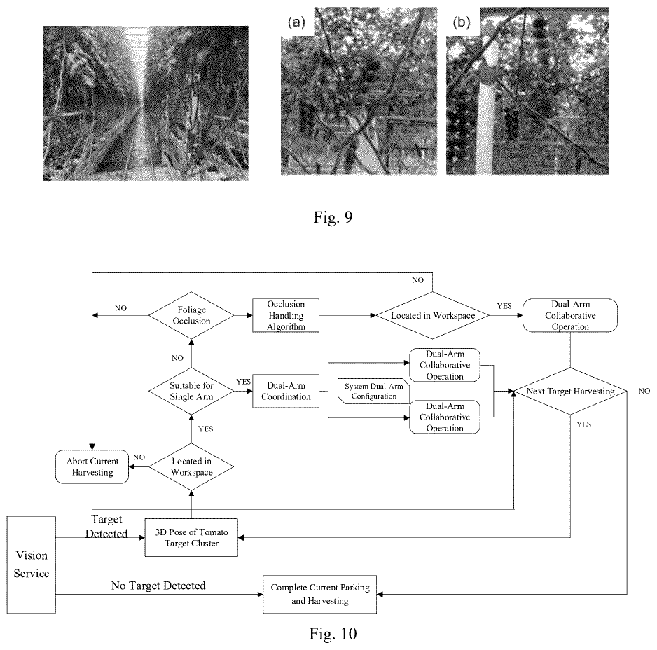

The tomato cultivation environment is unstructured, with natural randomness in growth patterns. Dense planting, intertwined branches or leaves, and inconsistent vertical or horizontal heights create risks of interference, collisions, and branch entanglement during simultaneous dual-arm harvesting robot operation, as shown in FIG. 9.

Dual-arm configuration principles: Collision avoidance—the motion workspaces of both arms must not overlap, collide, or interfere during harvesting.

Hybrid operation strategy: A combined parallel and sequential harvesting approach is adopted based on planting density.

Specifically: For high-density scenarios (parked robot, tightly clustered tomato bunches in a single visual frame), use single-arm harvesting with collision-avoidance stop sensors to prevent collisions; for low-density scenarios (sparsely distributed tomato bunches in a single visual frame), employ dual-arm simultaneous harvesting with collision avoidance.

In this embodiment, the harvesting vision camera is mounted on the end of the left arm.

Given the complexity of the aforementioned field environment, the dual-arm control method for harvesting implements the following:

Firstly, the motion workspaces of the dual arms must not overlap, and this spatial configuration is used to plan robotic arm trajectories.

Secondly, the central global motion controller allocates harvesting tasks based on target positions within the visual field. For example, assigning targets to the left or right arms according to their x-axis coordinate ranges in the camera frame.

A harvesting task represents a single robotic arm motion control process, where the motion control device is invoked based on detected target pose data, following the robotic arm motion control methodology described earlier.

Thirdly, the central controller synchronizes dual-arm tasks by first identifying targets entering the workspace via the left arm, initiating vehicle speed control, and parking the robot into harvesting mode. It ensures both arms complete their harvesting tasks before resuming patrol operations.

After confirming targets entering the workspace, the vehicle is controlled to park based on configured optimal harvesting position parameters. Once parked, the dual arms operate within their respective workspaces, initiating harvesting tasks and scheduling the use of the robotic arm motion control device for motion path planning to execute harvesting work. Until the work tasks of each arm are completed and no harvestable fruit clusters remain in the area, the system switches back to patrol mode for inspection, as shown in FIG. 10.

### (3) Target Tracking and Feedback: Position Servoing

Real-time target tracking and pose feedback are extremely critical for maintaining harvesting accuracy or success rate. In practice, anomalies in camera depth information caused by factors such as light reflection are not uncommon. In such cases, dynamic adjustments to the observation position are required, and robotic arm trajectories must be dynamically replanned.

### (4) Cutting-Clamping Mechanism

After the robotic arm end reaches the predetermined target position, a well-designed integrated cutting-clamping end effector is required to complete the final cutting and clamping operations. The mechanism uses a motor to control its final cutting posture and action implementation.

The present disclosure adopts dual-arm collaborative operation. The humanoid robotic arm configuration is more suitable for harvesting scenarios and enables more effective cooperation.

In the description of the present disclosure, it should be understood that the directional or positional relationships indicated by the terms “upper,” “lower,” “front,” “rear,” “left,” “right,” “vertical,” “horizontal,” “top,” “bottom,” “inner,” “outer,” and similar expressions are based on the orientation or positional relationships shown in the accompanying drawings. These terms are used solely to facilitate the description of the present disclosure and simplify the description, not to indicate or imply that the device or component referred to must have a specific orientation or be constructed and operated in a specific orientation. Therefore, these terms shall not be construed as limiting the present disclosure.

The foregoing has described specific embodiments of the present disclosure. It should be understood that the present disclosure is not limited to the specific implementations described above. Those skilled in the art may make various changes or modifications within the scope of the claims, which do not affect the substantive content of the present disclosure. When there is no conflict, the embodiments of the present disclosure and the features in the embodiments may be arbitrarily combined with each other.

What is claimed is:

1. A dual-arm harvesting robot system, comprising: a robot body, a collection device, a mobile device and a robot control device; wherein
the robot body is mounted on the mobile device via a rotating and lifting waist-hip joint, and the collection device is provided on the mobile device; the mobile device is configured to carry the robot body and the collection device to move;
a multi-degree-of-freedom mechanical right arm and a multi-degree-of-freedom mechanical left arm are provided on two sides of the robot body, a right-arm-end harvesting gripper is provided at a distal end of the multi-degree-of-freedom mechanical right arm, and a left-arm-end harvesting gripper is provided at a distal end of the multi-degree-of-freedom mechanical left arm;
an image acquisition device is provided on a top of the robot body, a LiDAR device is provided on the mobile device, and both the image acquisition device and the LiDAR device are in data communication with the robot control device; and
the robot control device is configured to control operations of the rotating and lifting waist-hip joint, the multi-degree-of-freedom mechanical right arm, the multi-degree-of-freedom mechanical left arm, the right-arm-end harvesting gripper, the left-arm-end harvesting gripper and the mobile device.

2. The dual-arm harvesting robot system according to claim 1, wherein the image acquisition device is a first depth camera;
the first depth camera is connected to the robot body via a neck rotating joint, and the first depth camera is configured to perceive environment;
a second depth camera is provided on the robot body, and the second depth camera is configured to perform close-range obstacle avoidance and dynamic path planning; and
a third depth camera is provided on the left-arm-end harvesting gripper, and the third depth camera is configured to detect target objects for harvesting.

3. The dual-arm harvesting robot system according to claim 1, wherein the mobile device comprises a mobile chassis; the mobile chassis is provided with a rear chassis track wheel, a rear chassis caster wheel, a chassis drive wheel, a front chassis track wheel and a front chassis caster wheel;
the front chassis track wheel and the front chassis caster wheel are located at a front end of the mobile chassis, and the rear chassis track wheel and the rear chassis caster wheel are located at a rear end of the mobile chassis; and
the chassis drive wheel is located between the front chassis track wheel and the rear chassis track wheel.

4. The dual-arm harvesting robot system according to claim 3, wherein the LiDAR device comprises a rear LiDAR and a front LiDAR;
the rear LiDAR and the front LiDAR are provided on the mobile chassis, the rear LiDAR is located at the front end of the mobile chassis, and the front LiDAR is located at the rear end of the mobile chassis; and
a rear anti-collision strip is provided at the rear end of the mobile chassis, and a front anti-collision strip is provided at the front end of the mobile chassis.

5. The dual-arm harvesting robot system according to claim 1, wherein the multi-degree-of-freedom mechanical right arm is a six-degree-of-freedom mechanical right arm;
the six-degree-of-freedom mechanical right arm comprises: a first right arm joint, a second right arm joint, a third right arm joint, a fourth right arm joint, a fifth right arm joint and a sixth right arm joint connected sequentially;
the first right arm joint is connected to the robot body, and the sixth right arm joint is connected to the right-arm-end harvesting gripper;
the multi-degree-of-freedom mechanical left arm is a six-degree-of-freedom mechanical left arm;
the six-degree-of-freedom mechanical left arm comprises: a first left arm joint, a second left arm joint, a third left arm joint, a fourth left arm joint, a fifth left arm joint and a sixth left arm joint connected sequentially;
the first left arm joint is connected to the robot body, and the sixth left arm joint is connected to the left-arm-end harvesting gripper;
the rotating and lifting waist-hip joint comprises: a waist rotating joint, a first waist lifting joint and a second waist lifting joint connected sequentially; and
the waist rotating joint is connected to the robot body, and the second waist lifting joint is connected to the mobile device.

6. The dual-arm harvesting robot system according to claim 1, wherein the robot control device comprises: a visual service device, a motion planning device, a robotic arm control device, a vehicle control device, a software communication device, a Python-AB-API device and a natural language interaction device;
the visual service device is configured to capture scene image data via the image acquisition device, segment harvesting targets from the scene image data using a visual weighting model file, and calculate positional information of the harvesting targets;
the motion planning device is configured to plan motion paths for the multi-degree-of-freedom mechanical right arm and the multi-degree-of-freedom mechanical left arm based on the positional information of the harvesting targets and workspace configurations;
the robotic arm control device is configured to receive the motion paths from the motion planning device and control the multi-degree-of-freedom mechanical right arm and the multi-degree-of-freedom mechanical left arm to execute harvesting along the motion paths;
the vehicle control device is configured to interact with the LiDAR device, the LiDAR device performs simultaneous localization and mapping (SLAM) mapping and navigation, and the vehicle control device is configured to control operation of the mobile device;
the software communication device is configured to perform inter-device communication;
the Python-AB-API device is configured to invoke devices and/or receive information from the devices; and
the natural language interaction device is configured to implement human-machine interaction.

7. A dual-arm harvesting robot control method, wherein the dual-arm harvesting robot control method is configured to control the dual-arm harvesting robot system according to claim 1, comprising following steps:
vehicle chassis motion control step: performing SLAM mapping via the LiDAR device; planning a motion trajectory of the mobile device to enable the mobile device to navigate and patrol according to the motion trajectory; capturing real-time images of harvesting targets via the image acquisition device; tracking and detecting the harvesting targets based on the captured image data to obtain positional information of the harvesting targets; and adjusting a speed of the mobile device in real time based on the positional information of the harvesting targets;
robotic arm motion control step: defining motion spaces of the multi-degree-of-freedom mechanical right arm and the multi-degree-of-freedom mechanical left arm to position the harvesting targets within the motion spaces; determining joint angles of the multi-degree-of-freedom mechanical right arm and the multi-degree-of-freedom mechanical left arm via inverse kinematics based on the positional information of the harvesting targets; and obtaining collision-free motion paths for the multi-degree-of-freedom mechanical right arm and the multi-degree-of-freedom mechanical left arm based on the joint angles and collision-avoidance configuration parameters, enabling the right-arm-end harvesting gripper and the left-arm-end harvesting gripper to approach the harvesting targets without collision;
dual-arm collaborative motion control step: optimizing and adjusting the motion paths of the multi-degree-of-freedom mechanical right arm and the multi-degree-of-freedom mechanical left arm to prevent overlap of the motion spaces of the multi-degree-of-freedom mechanical right arm and the multi-degree-of-freedom mechanical left arm;
target tracking and feedback step: performing real-time tracking of the harvesting targets and feeding back poses of the harvesting targets; and dynamically adjusting the motion paths of the multi-degree-of-freedom mechanical right arm and the multi-degree-of-freedom mechanical left arm based on the poses of the harvesting targets; and
cutting and grasping step: completing cutting and grasping operations after the right-arm-end harvesting gripper and the left-arm-end harvesting gripper reach positions of the harvesting targets; and placing the harvested targets into the collection device.

8. The dual-arm harvesting robot control method according to claim 7, wherein the step of determining the joint angles of the multi-degree-of-freedom mechanical right arm and the multi-degree-of-freedom mechanical left arm via inverse kinematics comprises following steps:
robot model and coordinate system establishment step:
establishing coordinate systems for each joint of the multi-degree-of-freedom mechanical right arm and the multi-degree-of-freedom mechanical left arm using the Denavit-Hartenberg (D-H) parameter method; and assigning a number i (i=1, 2, . . . , 6) to each joint and defining D-H parameters for each joint:
a_{i−1}: link length, the distance from the z_{i−1}-axis to the z_i-axis along the x_{i−1}-axis;
α_{i−1}: link twist angle, the angle between the z_{i−1}-axis and the z_i-axis about the x_{i−1}-axis;
d_i: joint offset, the distance from the x_{i−1}-axis to the x_i-axis along the z_{i−1}-axis; and
θ_i: joint angle, the angle between the x_{i−1}-axis and the x_i-axis about the z_{i−1}-axis; and
using inverse kinematics to solve for the six joint angles: theta_1, theta_2, theta_3, theta_4, theta_5, and theta_6.

9. The dual-arm harvesting robot control method according to claim 7, wherein the step of obtaining collision-free motion paths for the multi-degree-of-freedom mechanical right arm and the multi-degree-of-freedom mechanical left arm comprises following steps:
modeling the robot's workspace in three-dimensional space, describing obstacles as polygons, and recording position and dimension parameters of the obstacles;
wherein the collision-avoidance configuration parameters comprise: robot shape and dimensions, comprising the robot's radius, length and width; robot motion constraints, comprising maximum velocity, acceleration and turning radius; and a safety distance, wherein the safety distance is a minimum distance between the robot and obstacles;
generating a collision-free path by applying a randomized tree search algorithm, iteratively creating random new points in three-dimensional space, expanding the search tree from a start point toward these points, and terminating the process when the tree reaches a harvesting target point;
fitting path points of the collision-free path into a smooth curve using spline interpolation method;
assigning appropriate velocities to each path point on the collision-free path according to the robot's motion constraints and task requirements;
monitoring the distance between the robot and surrounding obstacles in real-time during collision-free path generation process, to ensure compliance with the safety distance requirement at all operational moments; and
performing global collision detection on the entire collision-free path after completing generation of the collision-free path, to validate obstacle-free motion throughout the robot's complete trajectory, and replanning the collision-free path if collisions are detected.

10. The dual-arm harvesting robot control method according to claim 7, wherein the dual-arm collaborative motion control step comprises:
assigning harvesting targets within different spatial ranges to the multi-degree-of-freedom mechanical right arm and the multi-degree-of-freedom mechanical left arm based on positional information of harvesting targets extracted from the image data; and
determining entry of harvesting targets into the workspace through the multi-degree-of-freedom mechanical left arm, controlling movement speed and halting operations of the mobile device according to configured optimal harvesting position parameters after determining entry of harvesting targets into the workspace, and activating harvesting tasks in respective workspaces for the multi-degree-of-freedom mechanical right arm and the multi-degree-of-freedom mechanical left arm; scheduling and applying motion path planning from the robotic arm motion control step for harvesting operations, and continuing the process until no harvestable targets remain in the workspaces of the multi-degree-of-freedom mechanical right arm and the multi-degree-of-freedom mechanical left arm; and switching to an inspection state for navigation after completing harvesting operations.
